(19) United States
(12) Patent Application Publication
(10) Pub. No.: US 2011/0285369 A1
(43) Pub. Date: Nov. 24, 2011

(54) Three-switch step-down converter

(75) Inventor: Slobodan Cuk, Laguna Niguel, CA (US)

(73) Assignee: CUKS, LLC

(21) Appl. No.: 12/800,773

(22) Filed: May 20, 2010

(51) Int. Cl. G05F 1/563; G05F 1/56

(52) U.S. Cl. 323/282

(57) ABSTRACT

A three-switch step-down converter provides efficiency, size, cost and other performance advantages over the conventional two-switch buck converter and other step-down converters, over the entire duty ratio operating range.

Unlike buck converter which uses only inductive energy transfer, the three-switch step-down converter employs the capacitive energy transfer in addition to inductive energy transfer to result in much reduced losses and better utilization of the switches resulting in reduced cost of the silicon needed for given efficiency performance.

The present invention also introduces a new hybrid switching method, which implements for the first time use of odd number of switches, such as three in this case, which is strictly excluded from use in conventional Square-wave, Resonant and Quasi-resonant switching converters, which all require an even number of switches (2, 4, 6 etc.), operating as complementary pairs.

### FIELD OF THE INVENTION

The non-isolated switching DC-to-DC converters can be broadly divided into three basic categories based on their input to output DC voltage conversion characteristics: a) step-down only (buck converter), step-up only (boost converter) and step-down/step-up (flyback, SEPIC, and Ćuk converters). This invention relates to the step-down class of switching DC-to-DC power converters such as buck converter.

Classifications of currently known switching converters can also be made based on the type of the voltage and current waveforms exhibited by the switches into three broad categories:
a) Square-wave switched-mode conversion in which inductors are subjected to square-wave like voltage excitations and are volt-second (flux) balanced over the entire switching period.
b) Resonant converters (sometimes called true resonant converters) such as series resonant and parallel resonant converters (Ref 1) in which a single additional resonant inductor is also flux balanced over the entire switching interval so that either switch voltages or switch currents are sinusoidal-like over the entire switching cycle with their peak magnitude several times higher than the square wave equivalent resulting in higher voltage and or current switch stresses than square-wave converters;
c) Quasi-Resonant Square-Wave converters, which are Square-wave converters modified by insertion of the resonant components, resonant inductors and/or resonant capacitors with objective to modify the short switching transitions only so that switching losses could be reduced. They also result in increase of either voltage or current stresses on the switches or increase of both.

The present invention creates a fourth category of the hybrid-switching converters consisting of same inductors obeying square-wave switching, but also having a resonant inductor which is flux balanced completely during only one part of the switching cycle, either ON-time interval or OFF-time interval. This results in unique three-switch converter topologies as opposed to the two or four switch topologies, which are required in all prior-art converters of the three categories described above. Because of the mixed use of the square-wave switching and unique resonant switching a term hybrid-switching method is proposed for this new switching power conversion method.

Another classification can be made with respect to number of switches used, such as two, four, six etc. The present Pulse Width Modulated (PWM) switched-mode power conversion theory a-priori excludes the converter topologies with the odd number of switches, such as 3 switches, 5 switches etc. (Ref. 2). The PWM switching method is based on the classical two square-wave switching intervals characterized by square-wave like current and voltage waveforms of its switches. The direct consequence is that switches come in complementary pairs, when one switch is closed its complementary switch is open and vice versa. Thus when half of the switches are ON their complementary switches are OFF and vice versa for second interval. Thus, the converters are characterized by two distinct switching intervals (ON and OFF) and even number of switches, such as 2, 4, 6, and cannot have an odd number of switches, such as 3, 5, etc.

The present invention breaks the new ground by introducing the switching converter featuring three switches, which results in hybrid switched-mode power conversion method and results in very high conversion efficiency.

The conventional step-down converter such as buck has two switches and linear DC gain conversion as a function of duty ratio. The new hybrid switching step-down converter has three switches and results in non-linear DC conversion gain providing higher step-down voltage conversion than the buck converter for the same operating duty ratio D.

### Objectives

The main objective is to replace the current prior-art buck converter, with the converter, which has inherently higher efficiency and smaller size. This is achieved by providing converter, which, in addition to inductive energy transfer only as in buck converter, provides an additional capacitive energy transfer from input to output. Both energy transfer mechanisms provide the increased total power to the load, while increasing efficiency and simultaneously reducing the size and weight.

### Definitions and Classifications

The following notation is consistently used throughout this text in order to facilitate easier delineation between various quantities:
1. DC—Shorthand notation historically referring to Direct Current but by now has acquired wider meaning and refers generically to circuits with DC quantities;
2. AC—Shorthand notation historically referring to Alternating Current but by now has acquired wider meaning and refers to all Alternating electrical quantities (current and voltage);
3. iₗ, v₂—The instantaneous time domain quantities are marked with lower case letters, such as i₁ and v₂ for current and voltage;
4. I₁, V₂—The DC components of the instantaneous periodic time domain quantities are designated with corresponding capital letters, such as I₁ and V₂;
5Δvᵣ—The AC ripple voltage on resonant capacitor Cᵣ;
6. Aᵣ—The AC ripple voltage on output capacitor C;
7. f_{S}—Switching frequency of converter;
8. T_{S}—Switching period of converter inversely proportional to switching frequency f_{S};
9. T_{ON}—ON-time interval T_{ON}=DT_{S} during which switch S is turned-ON;
10. T_{OFF}—OFF-time interval T_{OFF}=D′T_{S} during which switch S is turned-OFF;
11. D—Duty ratio of the main controlling switch S;
12. S₁, S₂ and S₃ switches—switch S₁ operates in complementary way to switches S₂ and S₃: when S₁ is closed S₂ and S₃ are closed and vice versa.
13. D′—Complementary duty ratio D′=1−D
14. fᵣ—Resonant switching frequency defined by resonant inductor Lᵣ and resonant capacitor Cᵣ;
15. Tᵣ—Resonant period defined as Tᵣ=1/fᵣ;
16. CR—two terminal Curreent Rectifer whose ON and OFF states depend on switch states of controlling switch S₁.
17. Lᵣ—Resonant inductor obeying resonant switching laws.
18. L—PWM inductor obeying PWM square-wave switching laws.
19. Cᵣ—Resonant capacitor obeying resonant switching laws.

### BRIEF DESCRIPTION OF THE DRAWINGS

FIG. 1a illustrates a prior-art buck converter, FIG. 1b illustrates the state of the switches for the buck converter of FIG. 1a, and FIG. 1c shows a prior-art buck converter of FIG. 1a implemented with semiconductor switching devices.

FIG. 2a shows an ideal switch which operates in all four quadrants, FIG. 2b shows a diode switch which operates in second quadrant, FIG. 2c shows a bi-polar transistor switch which operates in first quadrant, FIG. 2d shows an IGBT transistor switch which operates in first quadrant, FIG. 2e shows a MOSFET transistor switch which operates in first and fourth quadrants, FIG. 2f shows a composite voltage bi-directional switch (MOSFET and diode in series) which operates in first and second quadrants, FIG. 2g shows a Reverse Blocking IGBT transistor switch which operates in first and second quadrants.

FIG. 3a illustrates DC voltage gain characteristic for buck converter of FIG. 1a and FIG. 3b illustrates inductor current of the buck converter in FIG. 1a.

FIG. 4a shows a magnetic core with the air-gap needed for inductor of buck converter in FIG. 1a, and FIG. 4b shows the two-phase phase-shifted buck converter.

FIG. 5a illustrates the volt-second requirements for the inductor of the buck converter in FIG. 1a and FIG. 5b shows the volt-seconds as a function of the duty ratio D.

FIG. 6a shows a prior-art polarity inverting buck-boost converter, FIG. 6b shows a prior-art polarity non-inverting buck-boost converter, and FIG. 6c shows a prior-art switched-capacitor converter.

FIG. 7a illustrates the first embodiment of the present invention and FIG. 7b illustrates the states of three controllable switches for the converter of FIG. 7a.

FIG. 8a illustrates another embodiment of the present invention of FIG. 7a with two controllable bi-polar transistors and one diode, and FIG. 8b illustrates the states of two controllable switches for the converter of FIG. 8a.

FIG. 9a illustrates a branch comprising a bi-polar transistor in series with an inductor, and FIG. 9b illustrates the voltage waveform of inductor when current through bi-polar transistor in FIG. 9a is suddenly interrupted.

FIG. 10a illustrates another embodiment of the present invention of FIG. 7a with two controllable MOSFET transistors and one diode, and FIG. 10b illustrates yet another embodiment of the present invention of FIG. 7a with three controllable MOSFET transistors.

FIG. 11a illustrates another embodiment of the present invention of FIG. 7a with two controllable MOSFET transistors and one controllable Reverse Blocking IGBT transistor switch, and FIG. 11b illustrates yet another embodiment of the present invention of FIG. 7a with two controllable IGBT transistors and one controllable Reverse Blocking IGBT transistor switch.

FIG. 12a illustrates linear switched network for converter of FIG. 10a for ON-time interval DT_{S} and FIG. 12b illustrates linear switched networks for converter of FIG. 10a for OFF-time interval (1−D)T_{S}.

FIG. 13a illustrates an equivalent circuit model for linear switched network of FIG. 12a and FIG. 13b illustrates an equivalent circuit model for linear switched networks of FIG. 12b.

FIG. 14a illustrates an equivalent circuit model for current trough inductor L during OFF-time interval, and FIG. 14b illustrates an equivalent circuit model for current trough inductor L during ON-time interval.

FIG. 15a shows the voltage waveform across the inductor L for both parts of the switching interval, FIG. 15b shows the current waveform through inductor L during both parts of the switching interval, and FIG. 15c shows the voltage waveform across the resonant capacitor Cᵣ. during both parts of switching interval.

FIG. 16a illustrates an equivalent circuit model for current trough the resonant inductor Lᵣ during OFF-time interval, FIG. 16b illustrates a simplified equivalent circuit model of FIG. 16a b with DC current levels eliminated as they cancel each other, and FIG. 16c illustrates further simplification of the equivalent circuit model for large output capacitor C, which is then shorted in the model of FIG. 16b.

FIG. 17a illustrates that the resonant inductor Lᵣ is exposed to the small Δvᵣ co-sinusoidal voltage excitation during OFF-time interval, and FIG. 17b illustrates the current waveform trough the resonant inductor Lᵣ during OFF-time interval.

FIG. 18a shows the input current waveform for converter of FIG. 10a, and FIG. 18b shows the current waveform through the resonant capacitor Cᵣ in converter of FIG. 10a.

FIG. 19a illustrates the DC current levels I_{R} and I_{RS} in the resonant inductor Lᵣ current waveform, FIG. 19b illustrates the time-domain current waveform through inductor L, and FIG. 19c illustrates that the time domain of the output current is a sum of the inductor L current of FIG. 19b and resonant inductor Lᵣ current of FIG. 19a.

FIG. 20a shows a DC conversion gain function of the buck converter plotted in dotted line in comparison with a DC conversion gain function of present invention plotted in solid line, and FIG. 20b shows the measured and ideal DC conversion gain function of the present invention in solid and dotted lines respectively.

FIG. 21a illustrates converter circuit when switch S₁ is OFF during OFF-time interval thus displaying the blocking voltage of the S₁ switch and FIG. 21b illustrates converter circuit during ON-time interval, when S₂ and S₃ switches are OFF displaying their blocking voltages.

FIG. 22a illustrates another embodiment of the present invention of FIG. 7a with three controllable MOSFET transistors, and FIG. 22b illustrates a prior-art buck converter implemented with two controllable MOSFET transistors.

FIG. 23a illustrates the output current waveform of the present invention during the OFF-time interval of 0.5T_{S} providing a 3:1 voltage conversion ratio, and FIG. 23b illustrates the output current waveform in a buck converter during the OFF-time interval of 0.67T_{S} providing the same 3:1 voltage conversion ratio.

FIG. 24a illustrates the output current waveform of the present invention during the switching interval T_{S} and providing a 3:1 voltage conversion ratio, and FIG. 24b illustrates the output current waveform in a buck converter during the switching interval T_{S} providing the same 3:1 voltage conversion ratio.

FIG. 25a illustrates another embodiment of the present invention of FIG. 7a with the relocated resonant inductor Lᵣ, and FIG. 25b illustrates yet another embodiment of the present invention of FIG. 25a with the inductor L and resonant inductor Lᵣ windings placed on the same magnetic core.

FIG. 26a illustrates another embodiment of the present invention of FIG. 25a implemented with three MOSFET transistors and the relocated resonant inductor Lᵣ, and FIG. 25b shows a DC conversion gain function of the buck converter plotted in dotted line in comparison with a DC conversion gain function of present invention of FIG. 26a plotted in solid line.

FIG. 27a illustrates linear switched network for converter of FIG. 26a for ON-time interval DT_{S} and FIG. 27b illustrates linear switched network for converter of FIG. 26a for OFF-time interval (1−D)T_{S}.

FIG. 28a illustrates another embodiment of the present invention of FIG. 7a implemented with three MOSFET transistors and resonant inductor Lᵣ placed in series with switch S₂, and FIG. 28b shows yet another embodiment of the present invention of FIG. 7a implemented with a double-throw switch and a diode.

FIG. 29a shows the following salient waveforms from top to bottom: drain to source voltage of the main switch, resonant inductor current, inductor L current and output current for the experimental prototype operating at 50% duty ratio and 4V output voltage, and FIG. 29b illustrates the same salient waveforms but displays the measurements of the mean (average) value of the respective currents.

FIG. 30a shows the same currents as FIG. 29a but also displays their rms current values, and FIG. 30b illustrates the salient waveforms of the experimental prototype for the operation at duty ratio of 0.33 and 3V output voltage.

FIG. 31a shows the same salient waveforms as FIG. 29a but with the measured mean (average) values and FIG. 31b illustrates the same salient waveforms as FIG. 29a but with the measured rms current values displayed.

FIG. 32a shows the salient waveforms of the experimental prototype for the operation at light load current of 3 A and FIG. 32b illustrates the salient waveforms of the experimental prototype for the operation at 7.5 A load current.

FIG. 33a shows the salient waveforms of the experimental prototype operation at 14 A load current and FIG. 33b illustrates the salient waveforms of the experimental prototype for the operation at 18 A load current.

FIG. 34a shows the salient waveforms of the experimental prototype when the OFF-time interval is selected to be longer than the 50% of the resonant interval so that resonant current is going below zero current level (see resonant inductor current trace) and FIG. 34b illustrates the salient waveforms of the experimental prototype when the OFF-time period is selected to be shorter than 50% of the resonant period so that resonant inductor current is cut-short and never reaches zero current level.

FIG. 35a shows the voltage of the resonant inductor (second trace) displaying its DC value and superimposed AC ripple voltage and the output voltage (third trace) displaying the output DC voltage and its superimposed AC ripple voltage and FIG. 35b illustrates the magnified AC ripple voltages on the resonant capacitor and output voltage respectively obtained for 15 A load current.

FIG. 36a shows the same waveforms as FIG. 35a but for 7.5 A load current and FIG. 36b illustrates the same waveforms as FIG. 35b but for 7.5 A load current.

FIG. 37a shows the salient waveforms of the experimental prototype when the switch S₂ is implemented as a diode resulting in Discontinuous Inductor Current Mode (DICM) and in zero current interval in output current and FIG. 37b illustrates the same waveforms for operation deeper in DICM mode.

FIG. 38a shows the efficiency measurement results of a 200 W, 48V-to-12V prototype, and FIG. 38b show the power losses measured on a 200 W, 48V-to-12V prototypes.

FIG. 39a shows the efficiency measurements of the 200 W, 48 v to 12V prototype operating at 100 kHz and using RM8 magnetic core; the three efficnecy curves for 5 A, 10 and 15 A are displayed over the input voltage regulation range of 36V to 54V. FIG. 39b shows the corresponding loss measurements.

FIG. 40a shows the efficiency measurement results of a 50 W, 12V-to-1.5V prototype operating at 56 kHz, and FIG. 40b shows the power losses measured on a 50 W, 12V-to-1.5V prototype.

FIG. 41a shows the third party efficiency measurement results of their 40 W, 12V-to-1.3V buck converter prototype operating at 1 MHz switching frequency, and FIG. 41b shows the power losses measured on the above 40 W, 12V-to-1.3V prototype.

FIG. 42a shows the phase-shifted application of the three-switch step-down converter using two converters operating at 50% duty ratio and FIG. 42b shows the state of the six switches.

FIG. 43a shows the total input current of the converter in FIG. 42a and FIG. 43b shows the total output current of the converter in FIG. 43b.

### PRIOR-ART

### Prior-Art Buck Converter

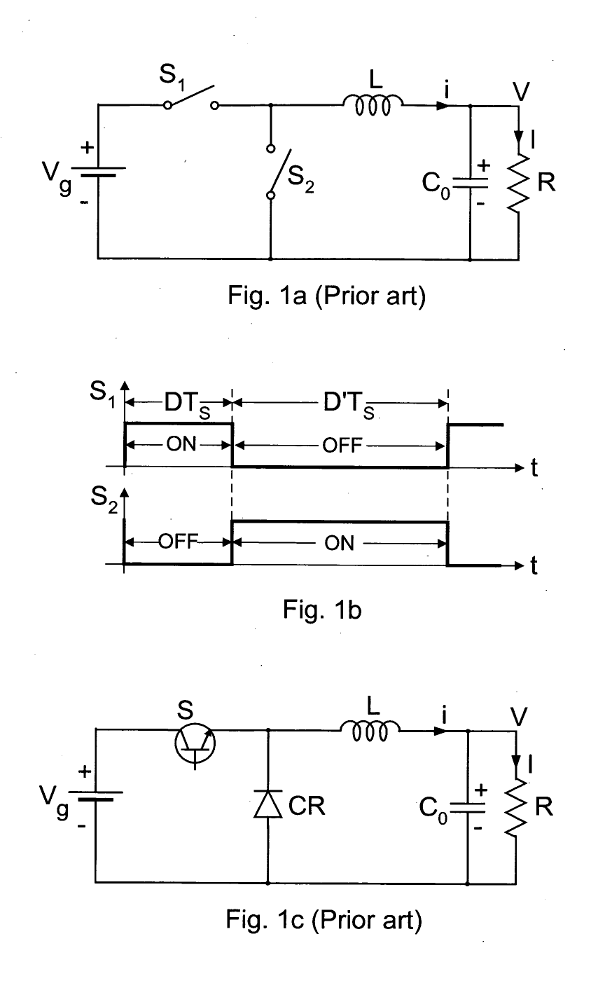

The non-isolated prior-art Pulse Width Modulated (PWM) buck switching converter shown in FIG. 1a consists of two complementary switches: when S₁ is ON, S₂ is OFF and vice versa (in continuous conduction mode) as shown by the switch states in FIG. 1b. It is capable of step-down only of the input DC voltage dependent of operating duty ratio D, which is the ratio of the ON time of switch S₁ and switching period T_{S}.

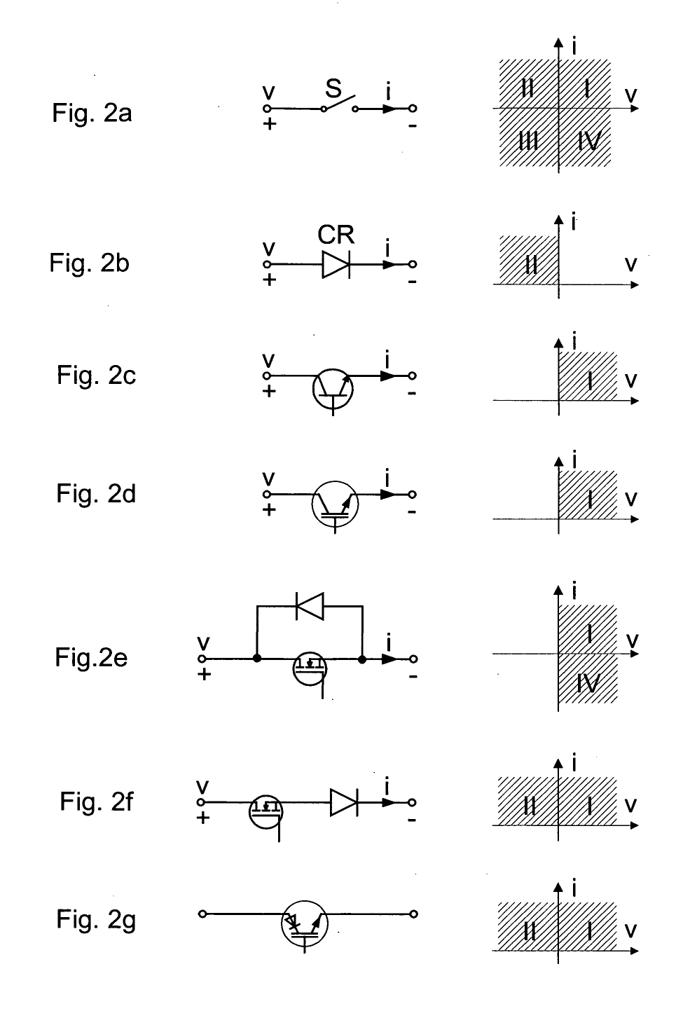

The minimum implementation of semiconductor switches in buck converter is shown on FIG. 1c where switch S₁ is a bipolar transistor and switch S₂ is a current rectifier. Possible semiconductor switches with their current conduction and voltage sustaining capabilities are shown in FIGS. 2a-e.

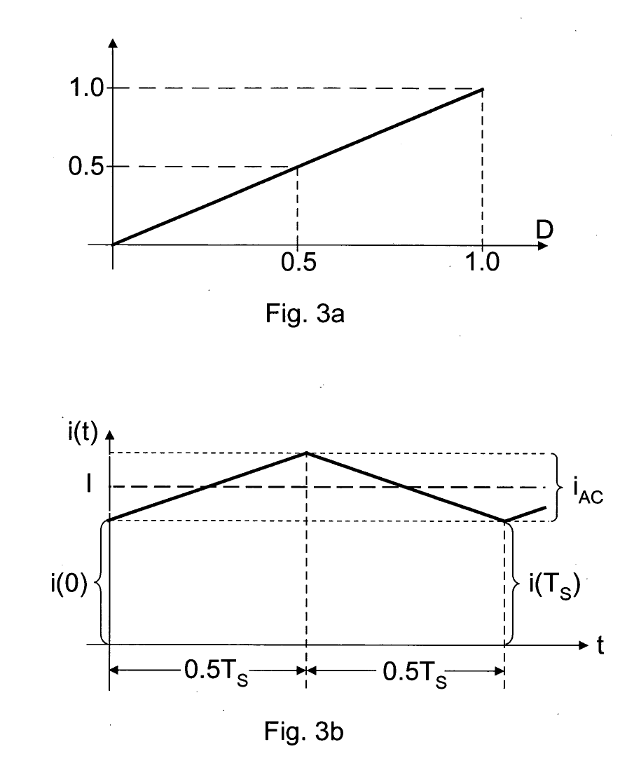

The linear step-down DC gain characteristic of the buck converter as a function of duty ratio D is illustrated in FIG. 3a and given by:

V=DV_{g} (1)

while FIG. 3b illustrates inductor current with characteristic triangular AC ripple current i_{AC} superimposed on DC current I.

The inductor L in the buck converter of FIG. 1a, must conduct a full DC load current so that its instantaneous inductor current waveform i(t) must have a DC bias equal to DC load current and a superimposed AC triangular ripple current as in FIG. 3b. This implies that the inductor L must store a DC energy W equal to W=LI²/2. As a consequence, the inductor must be built.

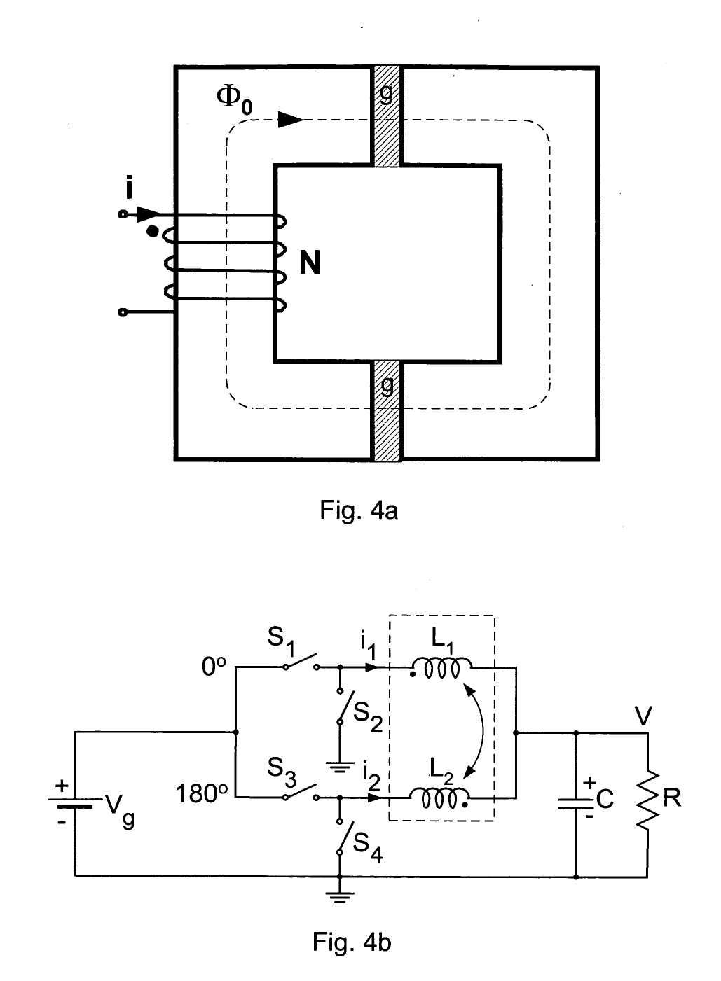

In order to store this DC energy inductor must be built with an air-gap such as shown in FIG. 4a, whose size is directly proportional to the DC energy, which needs to be stored. Clearly, addition of the air-gap reduces the inductance L dramatically. This, therefore further increases the size of the core needed to provide acceptable AC ripple current of around 20% peak to peak relative to DC current I. Ultimately, for a very large DC currents (100 A or more), the air-gap needed is so large, that the magnetics core only increases its inductance a factor of two or three compared to an inductor of the same size without core material. Considering that present day ferrite material have a relative permeability of 2,000 or more, that results in reduction of inductance by a factor of 1000.

Size of the inductance is therefore severely affected by its need to store the DC energy. However, inductor size is in addition also required to be very large because it must also support a superimposed AC flux. In order to better utilize the magnetics for the low voltage converters with high DC load current such as 12V to 1V, 30 A Voltage Regulator Modules (VRM) the paralleled connection of several buck converters shifted in phase is used. The two-phase prior art buck converter is illustrated in FIG. 4b, which also displays the coupled inductor extension, which is employed to reduce the output ripple voltage and the size of the magnetic while improving the transient response. The above use of two phase shifted converter will be also lead to further performance improvements of the present invention as described in last section on System Applications.

This large AC flux leads to large volts-seconds imposed on the core as given by:

Volt-sec=V(1−D)T_{S} (2)

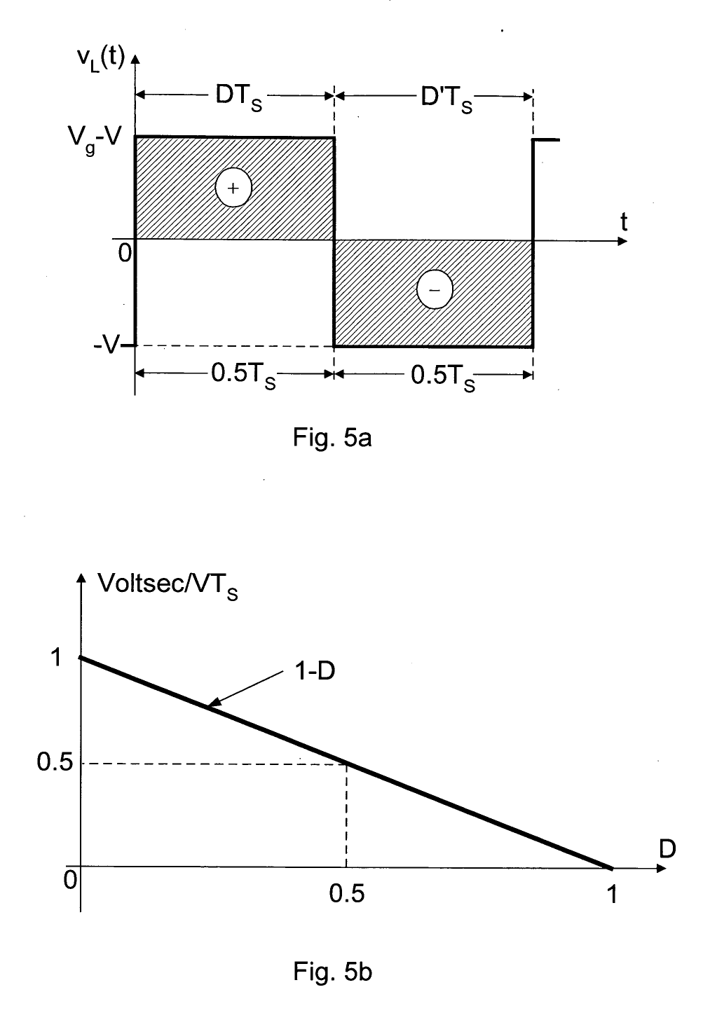

The graph of Volt-seconds as a function of duty ratio is shown in FIG. 5b. Note that for large step down (D small), the volt seconds are approaching VT_{S}, where V is regulated output DC voltage V.

In summary, the size of the inductor L in the prior-art buck converter is very large due to the two basic requirements:
a) need for large DC energy storage;
b) large AC volt seconds imposed on the inductor.

The present approaches to minimize inductor size was to increase switching frequency indiscriminately to the high levels, such as 1 MHz and even 2 MHz, so that small inductance values will be sufficient. This clearly impacts the efficiency.

### Other Prior-Art Converters

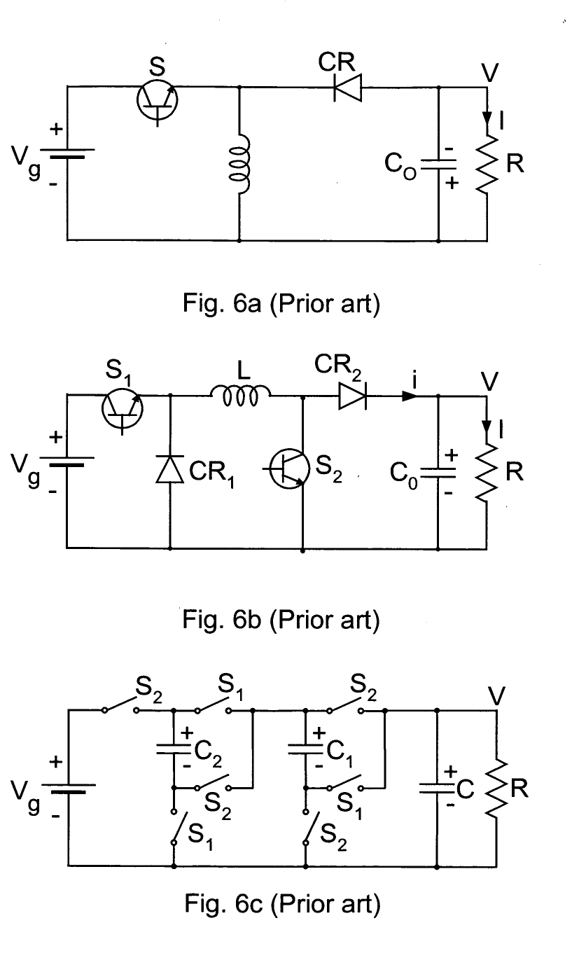

Prior art buck-boost converter is illustrated in FIG. 6a. It is capable of both voltage step-down as well as voltage step-up, but results in polarity inverting output voltage. The polarity non-inverting buck-boost converter shown in FIG. 6b must have 4 switches in accordance with the general theory of PWM switching converters that their switches come in complementary pairs. Both converters of FIG. 6a and FIG. 6b have the same limitations as the buck converter of FIG. 1a and are based on inductive energy transfer only.

The converter of FIG. 6c consists of capacitors and switches only, so the energy transfer is based solely on capacitive energy transfer. These switched-capacitor converters, as they are known in literature, have been at present limited to the very low power of under a one Watt and are also characterized by poor efficiency.

### SUMMARY OF THE INVENTION

### Basic Operation of the Three-Switch Step-Down Converter

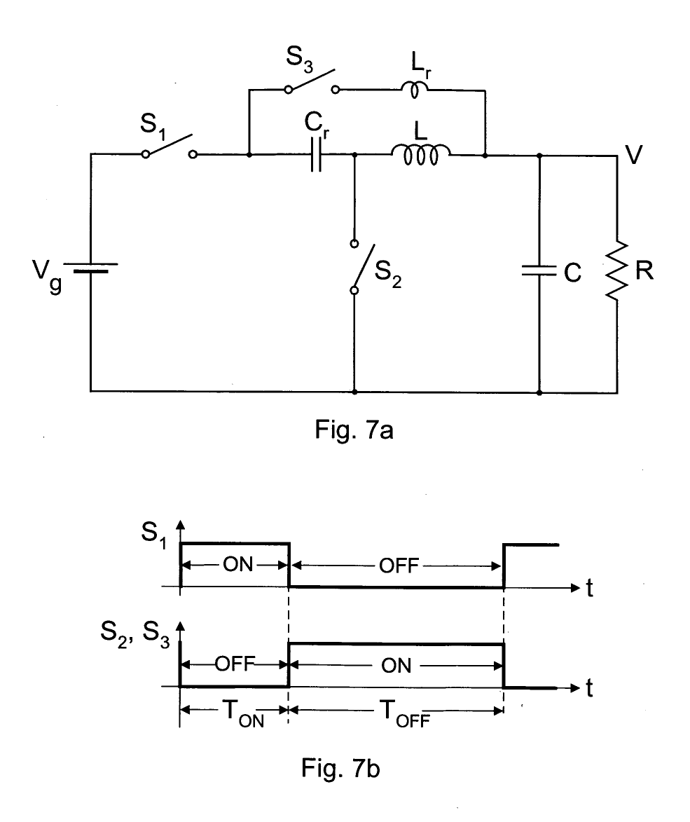

The present invention is shown in FIG. 7a in its basic form with ideal switches. The switching topology features a rather unorthodox configuration consisting of three switches, resonant capacitor Cᵣ and two inductors: (PWM) inductor L and resonant inductor L_{T}. The state of the three switches is shown in FIG. 7b confirming that the converter operates with just two switching intervals: ON-time interval T_{ON} and OFF-time interval T_{OFF} within a single switching cycle T_{S}.

Such a configuration with three switches is not possible in conventional square-wave PWM and conventional true resonant switching converters (Ref 2 and Ref 3). However, here it is essential for its operation and is made possible by the new hybrid-switching method, which uses a unique combination of the square-wave switching and resonant switching.

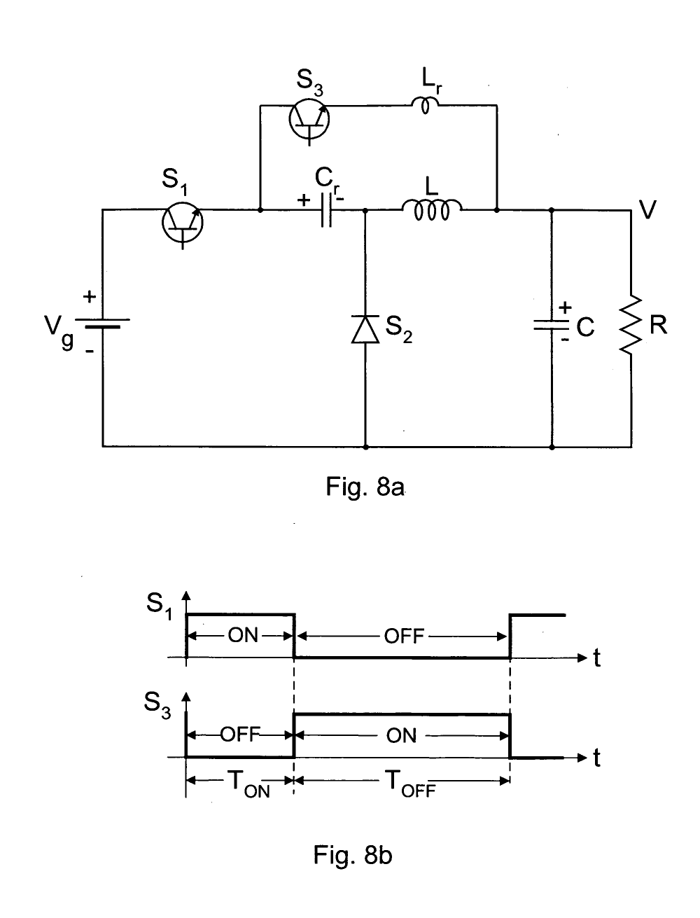

Single quadrant switches as per switch classification illustrated in FIG. 2b, FIG. 2c, and FIG. 2d can replace the ideal switches in the converter of FIG. 7a. Therefore, the two ideal switches S₁ and S₃ can be replaced with bipolar transistors, and switch S₂ with a simple diode to result in the converter of FIG. 8a. In this case, only the active switches S₁ and S₃ are controlled and driven by external drive resulting in their switch states as shown in FIG. 8b.

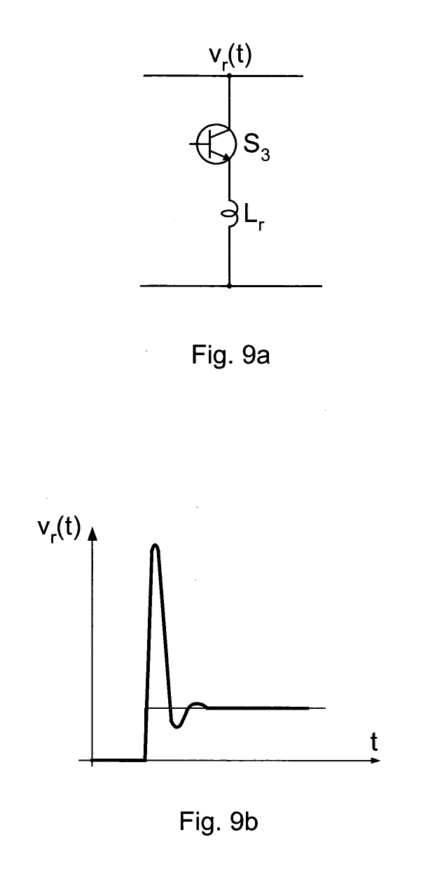

In addition to the inductor L connected to the load, this converter also has another inductor Lᵣ connected in the branch with active switch S₃. Conventional square-wave converters explicitly forbid such a placement of the inductor for apparently obvious reason: the inductor current cannot be interrupted as it will develop a huge voltage spike across inductor and result in large voltage exceeding rating of the switch and hence in its destruction as illustrated in FIG. 9a and FIG. 9b. The following detailed analysis will, however, show that the converter of the present invention operates in such a way that this placement of the inductor Lᵣ in switch branch S₃ is not only permissible, but also actually crucial for the operation of the converter and its many advantages.

For the steady-state to be established with periodic repetitive switching, the passive diode switch S₂ and in its basic mode of operation does not require any drive but is instead forced to turn-ON by the turn-ON of active switch S₃ and is forced to turn-OFF by the turn-ON of active switch S₁. The continuous control of the voltage step-down is then achieved by the modulation of the ON-time T_{ON} of the main controlling switch S₁ in FIG. 8b.

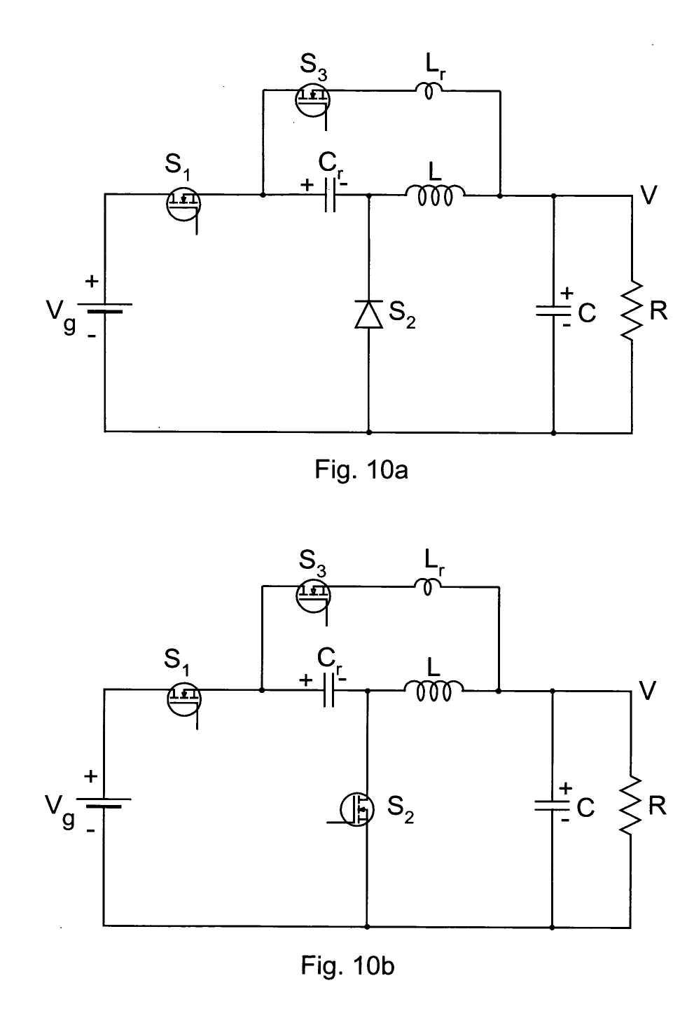

Due to the fast switching speed of the MOSFET transistors compared to bipolar transistor and consequent reduction of the size of storage components at higher switching frequencies, the MOSFET implementation of FIG. 10a is preferred. The MOSFET transistors are actually current bi-directional devices as they belong to the two-quadrant switch category (FIG. 2d). Note however, that the converter of FIG. 10a will still operate properly in its main mode of operation. However, there are additional modes of operation that could come as a result of current bi-directional nature of these switches, which, for example would allow the current flow back to the source under certain operating conditions. For this implementation, the switch states of FIG. 8b are applicable.

In low voltage and high current applications, such as for example, for 12V to 1.5V, 30 A output for Voltage Regulator Modules (VRM) the diode would generate too much conduction losses. Therefore, the diode switch is then replaced by another MOSFET transistor, which is operating as a synchronous rectifier so that the body diode of the MOSFET transistor is bypassed by conduction through the channel of the MOSFET. For the above 45 W VRM example, the state-of-the-art current MOSFET device with 0.5 mg) resistance will generate only 450 mW losses for 30 A output resulting in 1% power loss due to conduction loss of switch S₂. If the best Schottkey diode with 0.3V voltage drop were used, the conduction loss would be approximately 8 W or 18% of the output power. This therefore confirms the significance of an all MOSFET implementation of FIG. 10b. This implementation has the same switch states as in FIG. 7b for ideal switches.

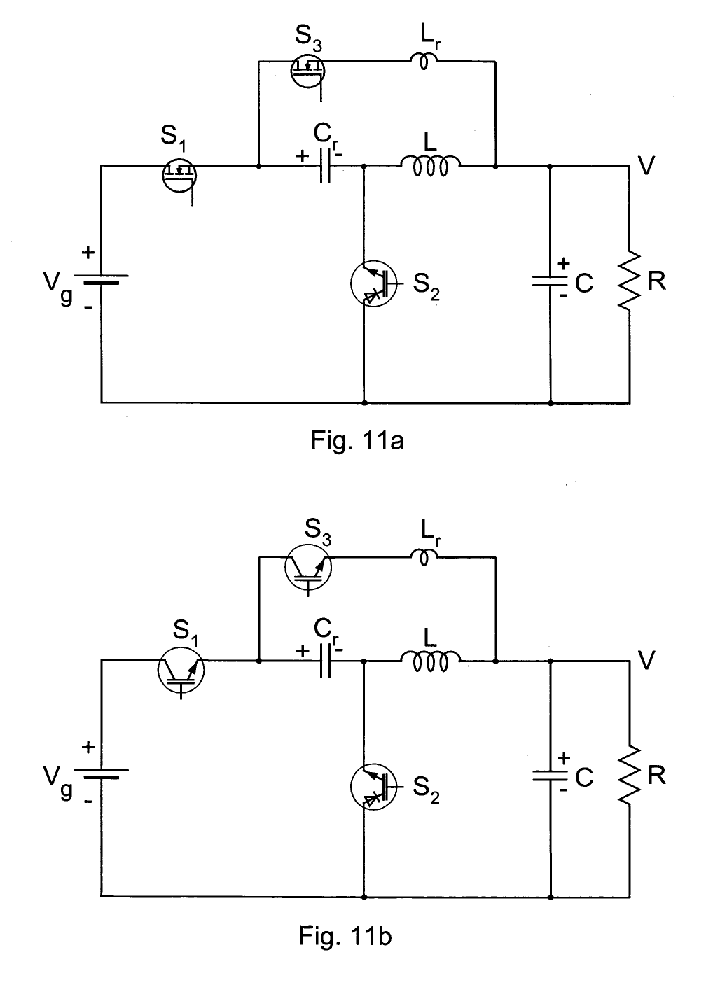

The diode switch in FIG. 10a can also be replace by an active switch, such as RB IGBT (Reverse Blocking Insulated Gate Bipolar Transistor) of FIG. 2d to result in the converter of FIG. 11a. Circuit operation is identical to that of FIG. 10a with diode. Another all IGBT transistor implementation is shown in FIG. 11b, with two IGBT transistors implementing S₁ and S₃ switches and single RB IGBT implementing S₂ switch.

The implementation of the switches illustrated in the above example is not intended to be exhaustive, as a number of other implementation of ideal switches of the converter in FIG. 7a can be also implemented by those skilled in the art, such as for example GTO (Gate turn-OFF thyristors), etc.

### Capacitive and Inductive Energy Transfer

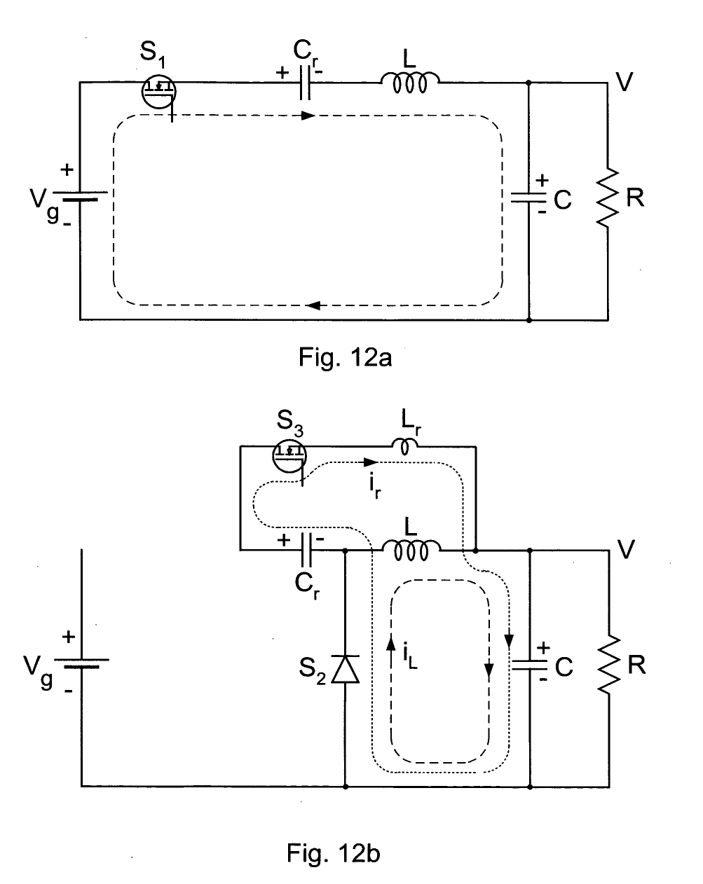

Irrespective of the particular switch implementation, all converter variants will result in two distinct switching networks, one for ON-time interval and another for OFF-time interval. For example, for the MOSFET transistor implementation of FIG. 10a the two resonant switching circuits are obtained: one for ON-time charge interval (FIG. 12a) and another one for OFF-time discharge interval (FIG. 12b) so that:
a) Charge interval T_{ON} (FIG. 12a): The source current is during this ON-time interval performing three tasks simultaneously: charging the resonant capacitor Cᵣ, storing the energy on inductor L and supplying the load current.
b) Discharge interval T_{OFF} (FIG. 12b): The stored energy on inductor L and capacitor Cᵣ is during this OFF-time interval is being released to the load, thus keeping the current in the load continuous and making low output ripple voltage possible with minimum output capacitance filtering. Ultra small resonant inductor Lᵣ facilitates the resonant capacitor Cr discharge into the load.

From FIG. 12a and the designation of charge and discharge of energy storage components, how during the ON-time interval, the inductor L is storing the energy (by increasing its current), while the resonant capacitor Cᵣ is also storing the energy (as the current flow is increasing its charge). The same capacitor charging current is being provided simultaneously to the load thus providing the load current during this interval.

From FIG. 12b it is apparent how during the OFF-time interval, inductor L is releasing its previously stored energy to the load. Note also that this inductor L is releasing its stored energy into a stiff output voltage source V due to relatively large output capacitance used to reduce the output ripple voltage. Therefore, this inductor L discharge will be linear unlike sinusoidal-like resonant charge during the ON-time interval. The resonant capacitor Cᵣ will be simultaneously discharging its stored energy directly to the load in a resonant fashion through a resonant inductor Lᵣ whose current will be increasing from zero current level to maximum and then back to zero current level. Thus during this OFF time interval the DC load is also being supplied with the current so that the load current is continuous while the source current is pulsating.

From the above it is obvious how in this hybrid switching conversion method, both capacitive and inductive energy transfers take place in transferring power from the source to the load efficiently. During the first ON-time charge interval, energy transferring capacitor Cᵣ and inductor L are storing the energy (in terms of charge on capacitor and increased current in inductor L). During the OFF-time interval both storage components are releasing its stored energy directly to the load with assistance of only a small resonant inductor Lᵣ and an additional active switch S₃.

Note the marked difference with respect to the energy transfer in the conventional buck converter of FIG. 1a. There is no capacitive energy storage and transfer, but only inductive energy, which must take the burden for transferring full load current. As the capacitive energy transfer is much more efficient and in addition much more compact than the inductive energy transfer (see Section below), one clearly should expect the significant efficiency improvements and size reduction due to use of both capacitive and inductive energy transfer of the hybrid-switching converter of FIG. 7a.

Such higher efficiency and smaller size is also evident from the fundamental equations for the source and load currents obtained by observations from FIG. 10a and FIG. 10b as:

ON time interval DT_{S}: i_{g}(t)=i_{L}(t) (3)

OFF time interval (1−D)T_{S}: i₀(t)=i_{L}(t)+iᵣ(t) (4)

Since the load current I consist of the average (DC) current through inductor L, designated as I_{L} and the average current I_{R} of the resonant inductor Lᵣ averaged over the whole switching interval T_{S}, equation (4) can be restated in terms of the respective DC currents as:

I_{L}+I_{R}=I (5)

Clearly, the inductor L in the conventional buck converter of FIG. 1a must carry the full load current I as there is no capacitive transfer DC current contribution I_{R} that is we have for Buck converter:

I_{R}=0 (6)

This directly results in the larger DC copper losses in buck inductor. Furthermore, this inductor also has the larger DC bias requiring proportionally larger air-gap and resulting in correspondingly higher peak ripple current, thus increased peak current of inductor at instant of turn-OFF and increased turn-OFF losses and switching losses. This is explained here on a qualitative basis, as the quantitative comparison is delayed until the proper analytical equations are developed in following section.

Note the absence of the resonant capacitor current contribution in the buck converter (6), which in addition to increased losses leads also to increased size of the buck converter inductor (see Section on comparison).

### Detailed Analysis of Three-Switch Step-Down Converter

We now undertake the detailed analysis of the non-inverting converter of FIG. 7a with the objective to find DC conversion ratio and the salient waveforms of the converter, such as current in inductors and voltages on capacitors. When the switches in FIG. 11a and FIG. 11b are shorted the equivalent circuit models of FIG. 12a and FIG. 12b are obtained.

We now use the principle of superposition of the linear networks to break down the equivalent circuit models for:

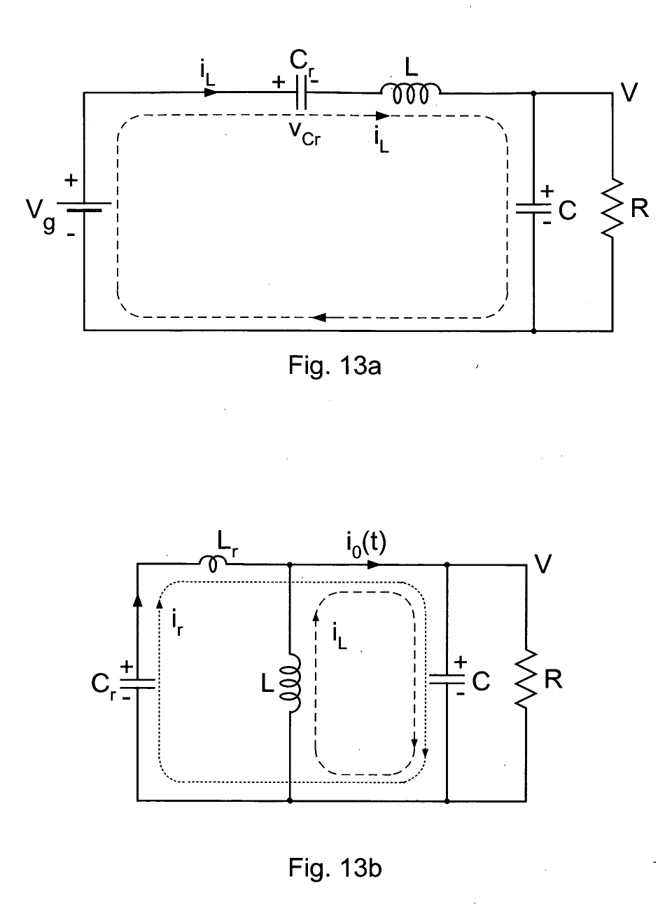

a) inductor L for ON-time interval in FIG. 13a;

b) inductor L and resonant inductor Lᵣ for OFF-time interval in FIG. 13b.

### DC Voltage Conversion Ratio

We now turn to evaluation of the DC voltage conversion ratio as a function of duty ratio D and possibly other quantities, such as two inductors, for example. We also assume a duty ratio control D of the main switch S₁.

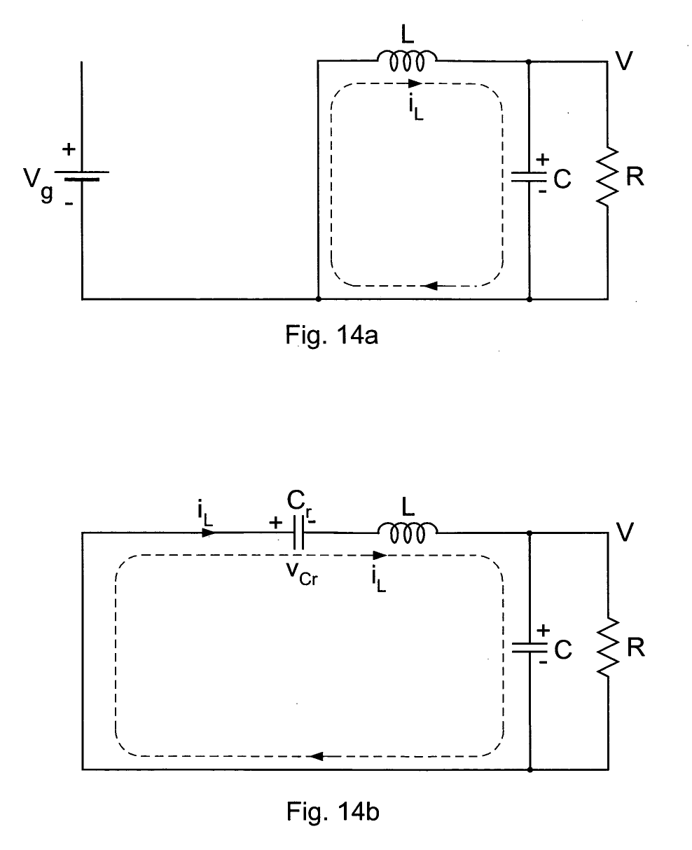

We now use a principle of superposition and break-down (split) the equivalent circuit models: one for inductor L in FIG. 14a and another for resonant inductor Lᵣ in FIG. 14b.

### Flux Balance on Inductor L

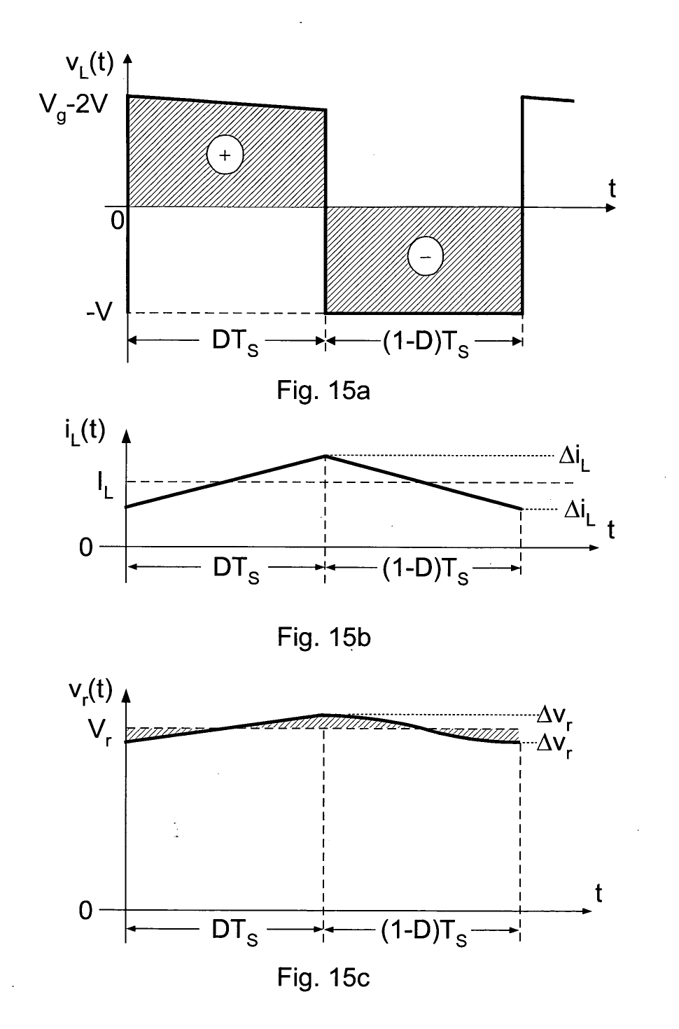

First, we analyze two linear switched networks for the inductor L shown in FIG. 13a and FIG. 14a. Note that the inductor L is subjected to the square-wave voltage excitations as in square-wave switching converters for both parts of the switching interval resulting in the voltage waveform across the inductor L as in FIG. 15a. Note that positive volt-seconds are determined by DC voltage level (V_{g}−V−Vᵣ) and NOT (V_{g}−V) as in buck converter. The negative volt-seconds are determined by DC voltage V. Thus, the flux balance or volt-second balance on inductor L leads to:

∫v_{Lr1}dt=(V_{g}−V−Vᵣ)D−V(1−D)=0 (7)

where we define:

T_{ON}=DT_{S}T_{OFF}=(1−D)T_{S} (8)

where T_{S} is the switching period.

The inductor L current has then the familiar triangular current wave shape superimposed on the DC current I_{L} (not DC load current I as in the prior-art buck converter) as seen in FIG. 15b.

Note also that during the ON-time interval, this DC bias current I_{L} is also charging the resonant capacitor Cᵣ resulting in the familiar ripple voltage of magnitude Δvᵣ superimposed on the DC value Vᵣ as seen in FIG. 15c for the ON-time interval.

### Flux Balance on Inductor Lᵣ

We now analyze a linear switched network for the resonant inductor Lᵣ shown in FIG. 14b. Thus, the flux balance or volt-second balance on inductor Lᵣ from the equivalent circuit in FIG. 14b and for interval D′T_{S} leads to:

∫vₗᵣdt=Vᵣ−V=0 (10)

The solution of (10) results in a unique solution for resonant voltage Vᵣ as:

Vᵣ=V (11)

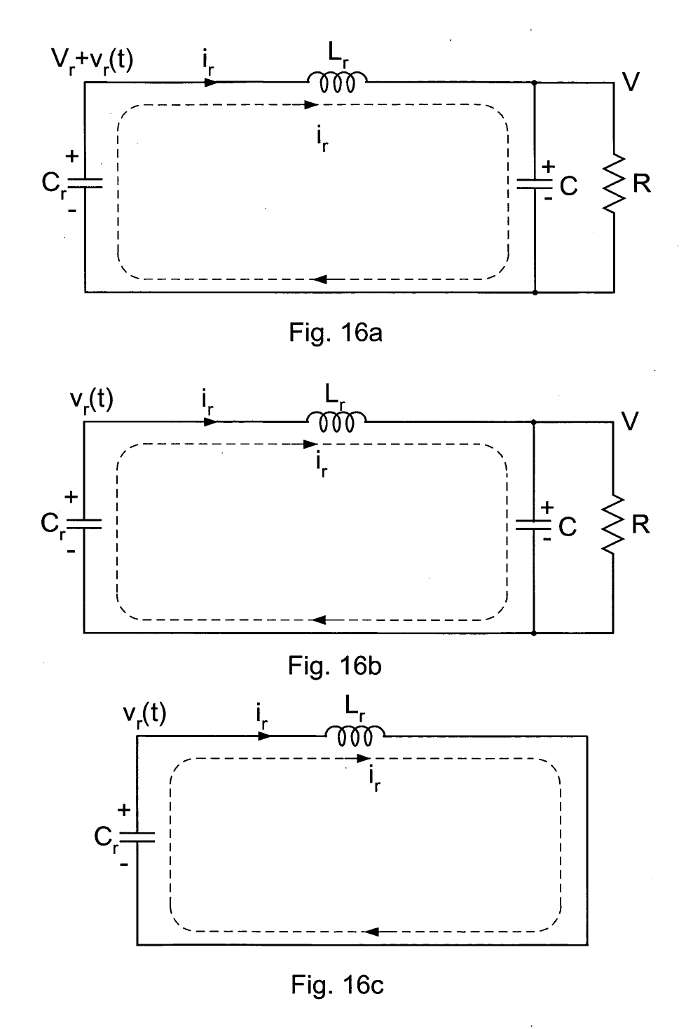

The equivalent circuit model of FIG. 16a reduces to that of FIG. 16b in which the DC bias levels V and Vᵣ are eliminated leaving the resonant circuit with only AC ripple voltage Δvᵣ excitation. We now make the simplifying and practical assumption that the output capacitor C is much larger than the resonant capacitor Cᵣ, that is:

C>>Cᵣ (12)

where even a factor of three to four is sufficient to satisfy it. Under that assumption, the capacitor C can be considered short and the equivalent circuit model of FIG. 16b is reduced to the one in FIG. 16c. This assumption (12) is not required for proper operation of the converter, but is desired, as it will make the resonant frequency fᵣ constant and independent of the capacitor C and thus independent of any additional capacitance C_{EXT} that the actual load might bring in addition.

Note that the resonance is solely contained during the OFF-time interval. Thus, the equivalent circuit of FIG. 16c is used in later Resonant Analysis Section to derive the resonant inductor current iᵣ(t) and resonant capacitor voltage vᵣ(t) time domain sinusoidal like variations.

Note from the equivalent circuit model of FIG. 16c that the resonant inductor Lᵣ voltage excitation are determined by a small AC ripple voltage Δvᵣ and not large voltage excitations determined by Vᵣ. Therefore AC flux excursions that resonant inductor Lᵣ is subjected to are much smaller by two orders of magnitude than inductor L since the voltage excursions applied to resonant inductor Lᵣ are limited to only the AC ripple voltage Δvᵣ which is typically 20 times smaller than DC value (5% relative ripple). This is shown in the time-domain waveform of the resonant capacitor Cᵣ on FIG. 15a. This is required by the continuity that instantaneous capacitor voltage must satisfy at the transition point for ON-time interval to OFF-time interval, so that the voltage at the end of ON-time interval must be equal to the voltage at the beginning of OFF-time interval, resulting in same Δvᵣ.

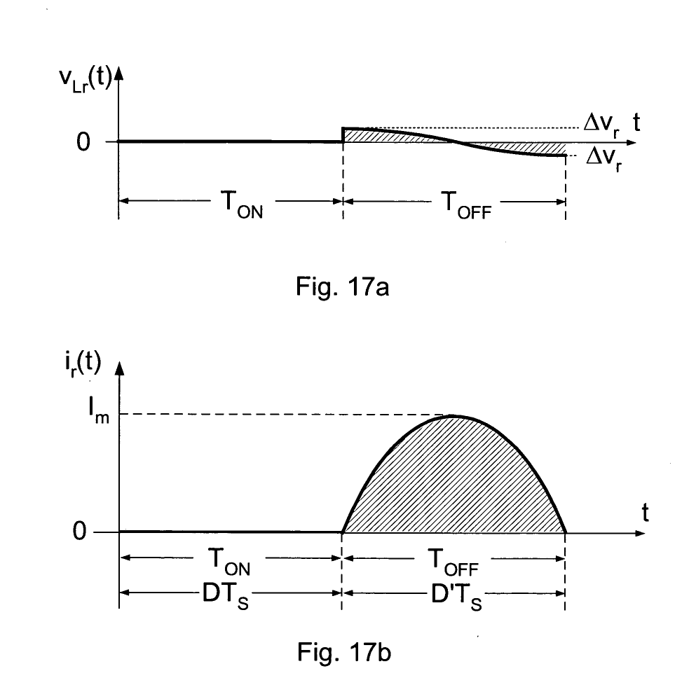

As seen from FIG. 17a the voltage excitation is not only much smaller (see shaded area) and not even square-wave, but instead of co-sinusoidal in shape with magnitude +Δvᵣ at the beginning of the OFF-time interval and −Δvᵣ at the end of OFF-time interval. This will result in the resonant inductor Lᵣ being much smaller than inductor L. Nevertheless, despite its small value and small size, the resonant inductor will conduct the sinusoidal resonant current as illustrated in FIG. 17b whose magnitude Iₘ is comparable to the output load current I or a fraction of it, depending on the operating point as the Resonant Analysis Section will reveal.

### DC Conversion Equations

From two flux balance equations, we can now calculate the voltage conversion ratio as follows:

Replacing (11) in (7) we obtain:

(V_{g}−2V)D−V(1−D)=0 (13)

which result in the DC conversion gain as:

V=V_{g}D/(1+D) (14)

Despite the presence of the resonant inductor Lᵣ and the sinusoidal resonance waveform of FIG. 17b, the DC conversion gain function (14) is obtained as a simple function of duty ratio D only and to the first order independent of the resonant inductor Lᵣ and inductor L values. Furthermore, the DC voltage on the resonant capacitor is equal to output DC voltage. This is why the net voltage across the resonant inductor Lᵣ is just the co-sinusoidal AC ripple voltage during OFF-time interval, since the DC voltages in the resonant circuit model of FIG. 16b subtract exactly leaving only AC ripple voltage in FIG. 16c. During ON-time interval, the AC ripple voltage is linear as dictated by the resonant inductor Lᵣ₁ but still having the same peak ripple voltage Δvᵣ as shown in FIG. 15c. The cancellation of the DC voltages across resonant inductor Lᵣ is the reason why the AC flux on this inductor is very small so that this inductor can be implemented with a very small size magnetic core and with small inductance so that in majority application, just an air core inductor with a single turn is sufficient for this resonance.

The simple DC conversion gain (14) makes possible the simple control implementation of the output DC voltage using standard PWM controller IC circuit.

We now calculate other DC quantities, such as the DC currents I_{L}, I_{R} and I_{g} in terms of the operating duty ratio D and the load current as follows. From the DC voltage conversion ratio (14) we can find the DC current conversion ratio from input to output as:

I_{G}=ID/(1+D) (15)

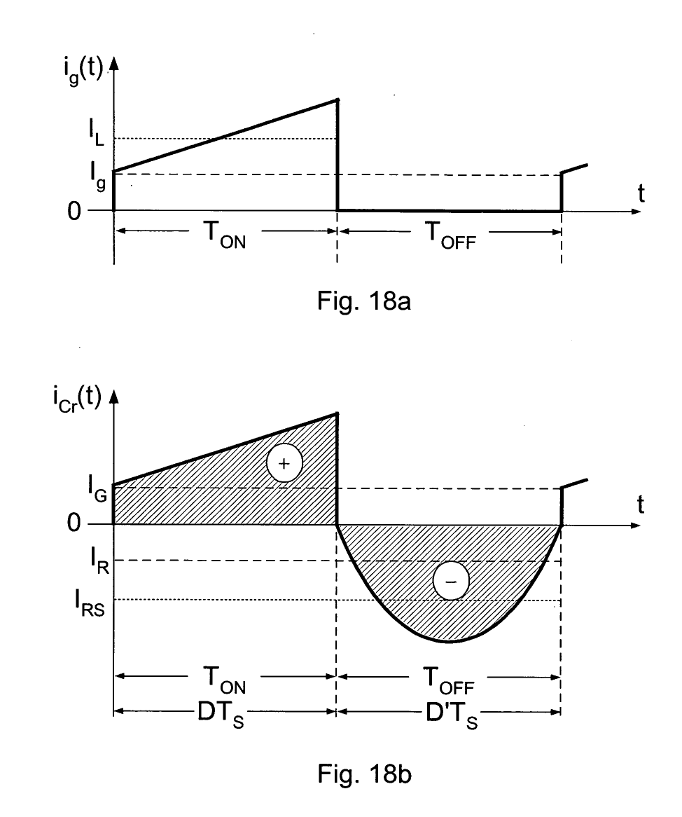

From the drawings of the time domain input current waveform i_{g}(t) and the marked DC current levels I_{L} and I_{g} in FIG. 18a we find another relationship among DC currents as:

I_{G}=DI_{L} (16)

Replacing (16) into (15) we obtain:

I_{L}=I/(1+D) (17)

Finally replacing (17) into (5) we obtain the solution for resonant current contribution I_{R}:

I_{R}=ID/(1+D) (18)

Note that (15) and (18) result in simple relationship:

I_{R}=I_{G} (19)

As a cross check, this can be easily verified from the time domain waveforms of the resonant capacitor current i_{Cr}(t) shown in FIG. 18b. The marked shaded areas in FIG. 17b designated plus and minus must be equal due to requirement for the charge balance on the resonant capacitor Cᵣ, which in turn leads to (19) as seen by marked averages I_{R} and I_{G}.

Marked in FIG. 18a is another average, the current I_{RS} which is the average of the sinusoidal current iᵣ(t) but not over the whole interval T_{S}, such as I_{R} current, but over the OFF-time interval only during which it really supplies the load. This current I_{RS} can be evaluated from:

I_{RS}=DI_{L}/(1−D) (20)

Replacing (17) into (20) we finally get:

I_{RS}=ID/(1−D²) (21)

The above DC current relationships can be used to calculate the losses in various branches of the converter of FIG. 7a and its many variants.

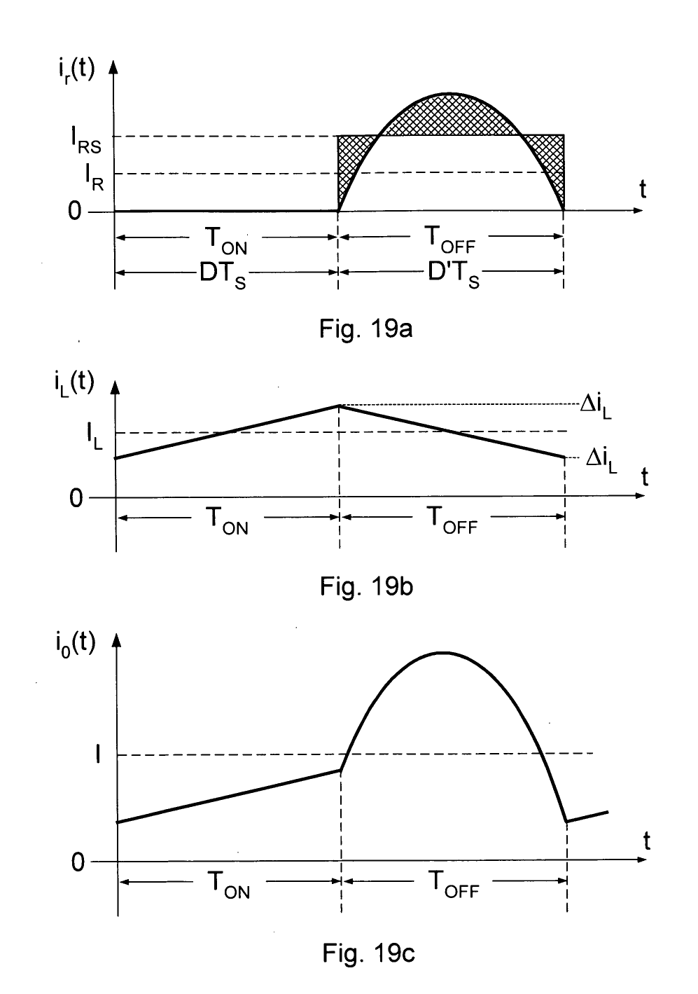

The DC current levels I_{R} and I_{RS} are highlighted again in the resonant inductor current waveform FIG. 19a. The time-domain waveform of inductor L current i_{L} is shown in FIG. 19b. As per (4) the time domain of the output current i₀ (t) is the sum of the inductor L current i_{L}(t) and resonant current iᵣ(t) and is shown in FIG. 19c.

### Comparison of DC Conversion Gains

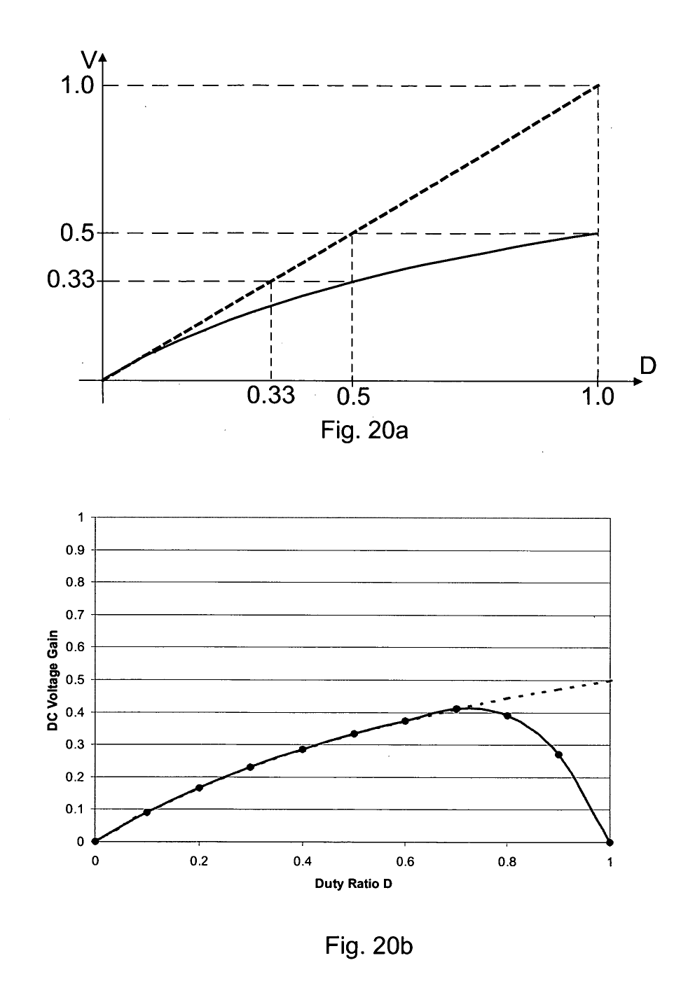

The DC conversion gain function of the buck converter is plotted in dotted line on FIG. 20a to provide the reference point. On the same FIG. 20a the ideal DC conversion gain of the present invention as given by (14) is plotted in solid line. It is immediately noticeable that the present invention has a higher step-down conversion ratio than buck converter for any operating duty ratio. For example, at duty ratio of 0.5 it provides a 3:1 step-down of the voltage as opposed to the 2:1 step down on the comparable prior-art buck converter. In fact, the prior-art buck converter must operate at lower duty ratio of D=1/3 in order to achieve the same voltage step-down. As discussed later, this has direct consequence on the lower efficiency and bigger magnetics size of the prior-art buck converter.

Note that idealized DC conversion gain as seen in FIG. 20a is maximum at duty ratio of 1 and is equal to 2:1 step-down, so that the prior-art buck converter can operate at duty ratio of 1.0 and result in 1:1 conversion ratio. The majority of applications, however, require the large step-down of the voltage. For example, the 48V input voltage supplied to most PC boards from the AC-DC power supplies is required to be reduced and regulated at 12V, hence a 4:1 conversion ratio is ultimately needed. Another large volume application is for Voltage Regulator Modules (VRM), which further convert the 12V bus voltage to power the microprocessors and other electronic loads at 1V to 2V, thus requiring 12:1 and 6:1 conversion ratios.

The experimental measurements of the DC conversion ratio of the present invention are shown in the graph in FIG. 20b. The measurements show a good agreement with the theoretical predictions, up to a duty ratio of 0.75. For higher duty ratios, the converter goes into a different mode of operation, which results in another step-down region beyond the point where the maximum DC conversion ratio is reached.

In another comparison for the discrete duty ratio given by:

D=1/n (22)

the DC conversion ratios for present invention and prior-art buck converters are given by:

V/V_{g}=1/(n+1) (23)

buck converter: V/V_{g}=1/n (24)

Higher conversion step-down (23) is clearly preferred since it will be shown in a later section that this results in additional advantages in terms of efficiency when compared to conventional buck converter.

Another advantage of the present invention over the prior-art buck converter is in substantial reduction of the turn-OFF losses of the switch S₁ compared to buck converter. This is due to reduced turn-OFF voltage. At 60% duty ratio the turn-OFF voltage is only approximately 60% of the buck converter, while turn-OFF current is about 50% of the buck converter resulting in four times reduction of turn-OFF losses under the same conditions. As the turn-OFF losses represent the dominant switching loss this translates into substantial efficiency improvements.

### Resonance Equations for OFF-Time Interval

In FIG. 15c we already anticipated the salient time domain voltage waveform on the resonant capacitor Cᵣ as consisting of a DC value Vᵣ and superimposed ripple voltage with linear increase during the ON-time and co-sinusoidal decrease during the OFF-time with the continuous transition between the two intervals with magnitude of the ripple at the transition instant designated as Δvᵣ. The actual time domain of resonant inductor voltage vᵣ(t) has been also anticipated in FIG. 17a and the actual time domain of the resonant inductor current iᵣ(t) in FIG. 17b.

We now undertake to develop the pertinent resonance equations, which will describe analytically such time domain solutions. The derived analytical results could then be used to calculate the component values needed for optimum operation of the converter.

From the resonant circuit model of FIG. 15c, we can now write the resonant equations:

Lᵣdiᵣ/dt=Vᵣ (25)

Cᵣdvᵣ/dt=−iᵣ (26)

whose solutions are:

iᵣ(t)=Iₘ sin ωᵣt (27)

vᵣ(t)=R_{N}Iₘ cos ωᵣt (28)

where R_{N} is characteristic impedance, ωᵣ is radial resonant frequency, fᵣ resonant frequency and Tᵣ resonant period given by:

R_{N}=\sqrt{Lᵣ/Cᵣ} (29)

ωᵣ=1/\sqrt{LᵣCᵣ} (30)

Tᵣ=1/fᵣ=2π\sqrt{LᵣCᵣ} (31)

Note the importance of the quantity Tᵣ. From the equivalent circuit model in FIG. 12b for the converter of FIG. 10a with diode implementation for switch S₂, the resonant current iᵣ has in its path the transistor and a diode connected in series. Such a combination is acting like a composite voltage bi-directional, current unidirectional switch, which can block the voltage of either polarity but conducts the current only in the diode current direction as confirmed by the two-quadrant characteristic of FIG. 2e. Therefore, the sinusoidal resonant current iᵣ will only be able to flow in positive directions, as its negative direction is being prevented from flowing by unidirectional current property of the diode. This will stop the sinusoidal resonant current flow at zero current level, and allow only a positive half-cycle of the resonant current to flow as illustrated in FIG. 17b.

### Optimum Output Voltage Control

### All MOSFET Implementation

There is another practical reason to choose that half of the resonant period Tᵣ be equal to the OFF-time interval, so that:

Optimal condition: T_{OFF}=0.5Tᵣ (32)

As described above and from (12), the resonant period is constant and independent of the output capacitance C value. For most practical applications requiring low to middle output voltages such as 1V, 12V or even 24V output and high load currents such as 15 A and higher load currents, an all MOSFET implementation of FIG. 10b is much preferred solution as the conduction losses of S₂ switch are minimized by use of the MOSFET transistors as synchronous rectifiers with low ON-resistance.

This configuration, however, does not prevent the resonant current flow in opposite directions, since the MOSFET implementation of switch S₂ as in FIG. 10b does allow such a current flow, since MOSFET transistor is a two-quadrant current bi-directional device as illustrated in FIG. 2e. Therefore, the condition (32) will insure that the reverse current flow (negative cycle of the resonant inductor current flow) is still prevented under all operating conditions despite the use of all MOSFET implementation of FIG. 10b. There is another important practical reason for use of an all MOSFET implementation of the Three Switch Step-down Converter as in FIG. 10b since it eliminates the Discontinuous Inductor Current Mode as described next.

### Elimination of Discontinuous Inductor Current Mode

DC voltage conversion gain for the prior-art buck converter given by (1) indicated that the DC voltage conversion gain is dependent on the duty ratio D only. More specifically it is NOT dependent on the load current. However, the minimal realization with the diode results in the load current dependency of the DC conversion ratio for light loads when the AC inductor ripple current becomes large when compared to the DC load current. Under those conditions, such converter enters the so-called Discontinuous Inductor Current Mode (DICM), and the DC voltage Conversion ratio becomes strongly dependent on the load. Although the regulation could still be performed by control of duty ratio D, this may require very low duty ratios and results in undesirable change of dynamic response when operating under the light load conditions. Both problems are sidestepped by implementing an all MOSFET switch implementation of FIG. 10b and the Discontinuous Inductor Current Mode is eliminated so that conversion ratio is independent of the load current for all load currents.

From (16) and (19) another important relationship emerges:

I_{R}=DI_{L} (33)

which displays the relative contribution of the capacitive energy transfer to the load through DC current I_{R} and inductive energy transfer through DC current I_{L}. For example, at the high duty ratio end, such as D=0.75 and 0.43 conversion ratio, the capacitive energy transfer made through resonant inductor Lᵣ contributes 75% of the DC load contribution made by inductive energy transfer through inductance L. At D=0.5 this contribution is still large 50% of the inductive contribution, while 3:1 voltage conversion is achieved simultaneously.

Note also as the ON-time interval and effective duty ratio D is decreased from D=0.75 to lower DC ratios such as D=0.5, 0.4 and 0.25, the peak ripple current of the inductor L will be proportionally reduced, thus resulting in smaller AC ripple of the inductor L and further away from the condition when the total output current is starting at zero current level.

The constant OFF-time interval, described above is a preferred method of control as it is most efficient and simplest to implement. Most standard IC controller chips can be made t operate in constant OFF time variable ON-time mode rather easily. However, if so desired, the constant switching frequency operation could be also implemented with some minor loss in efficiency.

### Equation for Output Zero Current Crossings

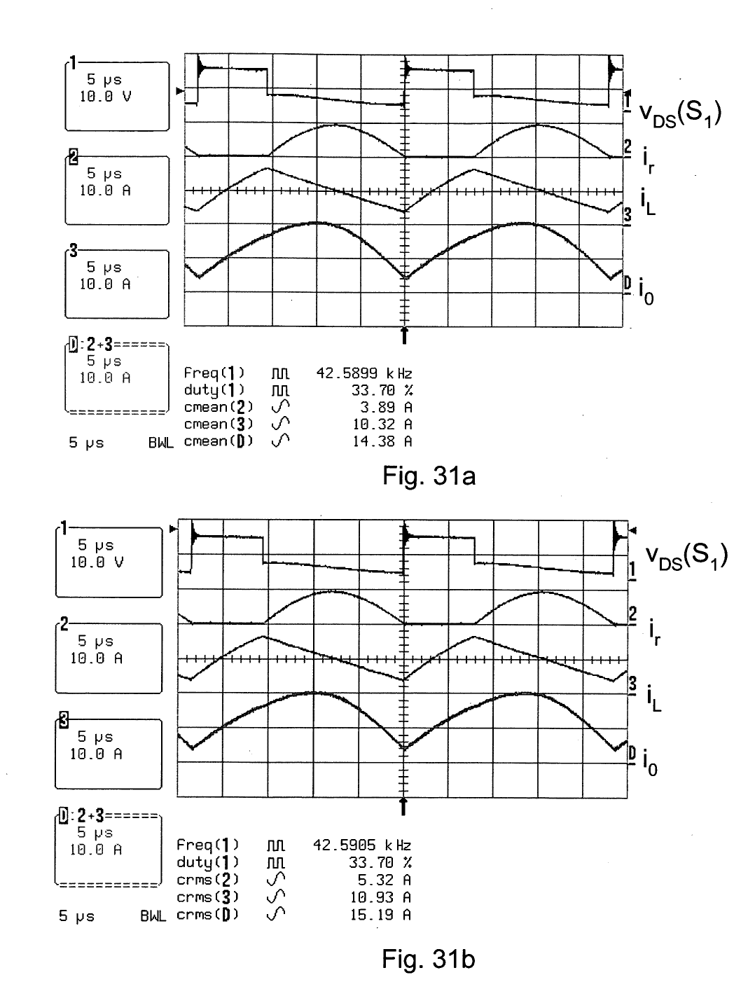

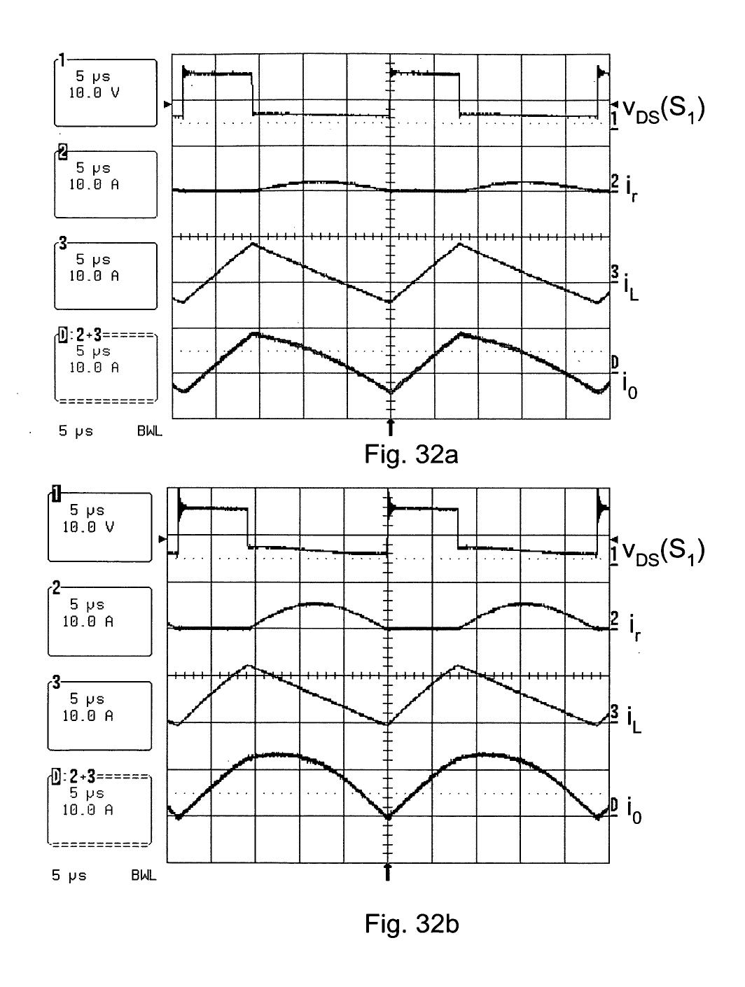

The output current i₀ shown in FIG. 19c starts and finishes at some positive current. Of particular interest is to determine a relationship among the converter parameters and operating conditions, duty ratio D and load condition (resistance R), when this waveform will start and finish at zero current level. At that instant all three switches are turning ON at zero current and except for S₁ switch, all switches are turning OFF at zero current level. This is then a dividing line as illustrated in FIG. 31a. For higher load currents the positive currents at beginning and end of switching interval are obtained as in FIG. 32b and for lower load current they are negative as in FIG. 32a.

We now develop the inequality which will make the instantaneous output current i₀ (t) at particular operating duty ratio D and output voltage V and load current Ito start at zero current level at the beginning of ON-time interval and finish at zero current level at the end of OFF-time interval. This condition is met when:

T_{OFF}V/L≦2I_{L} (34)

where I_{L} is DC current of the inductor L at the highest operating duty ratio and factor 2 above is to reflect that the peak inductor L current is two times higher than the DC current I_{L} at such extreme conditions of zero current turn-ON and zero current turn-OFF of inductor L current.

Using (17), (29) and (31), inequality could be rearranged into more revealing form:

L/Lᵣ≧0.5(1+D)πR/R_{N} (35)

R=V/I (36)

where R is the DC load resistance at operating point D. For operating point at D=0.5 we get simplified formula

L/Lᵣ≧π¾R/R_{N} (37)

As an example, for the converter operating with load current I=10 A and 5V output, load resistance is R=0.55Ω. For Lᵣ=1 μH and Cᵣ=25 μF, we calculate from (29) R_{N}=0.2Ω. Replacing those values in inequality (37) we get:

L/Lᵣ≧5.5 (38)

Therefore the choice for inductor L of 5.5 μH will result in zero current at turn-ON and zero current turn-OFF of inductor L current at D=0.5. Reducing duty ratio from that instant at the same load current of 10 A will result in increased DC bias current on inductor L and reduction of its peak current so that zero turn-ON and zero current turn-OFF of inductor L current is no longer available. However, the reduction of duty ratio will result in reduced peak ripple of inductor L and reduced turn-OFF current of the main controlling switch S₁ and its reduced turn-OFF losses.

### Voltage Stresses of the Three Switches

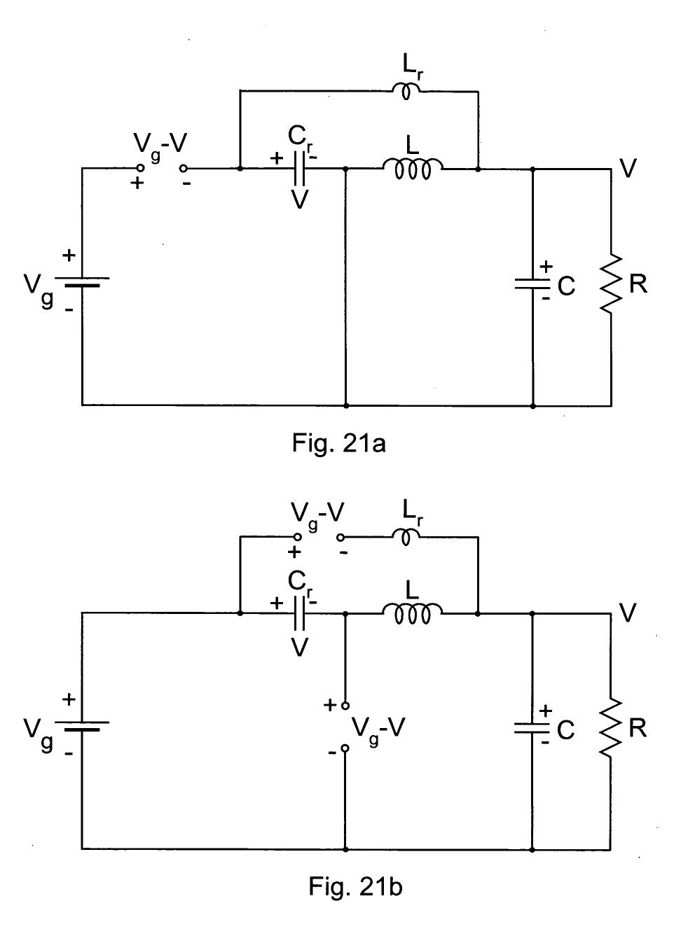

From the derived DC currents in all branches one can also derive analytical expressions for the rms currents in various branches so that the conduction losses could be calculated. What remains is to determine the voltage stresses of all switches so that the proper rated switching devices could be selected. From the circuit diagram for OFF-time interval in FIG. 21a and one for ON-time interval in FIG. 21b, the blocking voltages of all three switches are identical and equal for all operating duty ratio conditions and equal to:

V_{S1}=V_{S2}=V_{S3}=V_{g}−V (39)

For comparison, the voltage stresses for the buck converter are given by:

V_{S1}=V_{S2}=V_{g} (40)

For example for a D=0.5, voltage stresses are reduced to ⅔V_{g} as opposed to V_{g} in the buck converter. This clearly will lead to reduction of the turn-OFF losses of S₁ switch as the turn-OFF current is significantly lower than in the buck converter.
Comparison with the Buck Converter

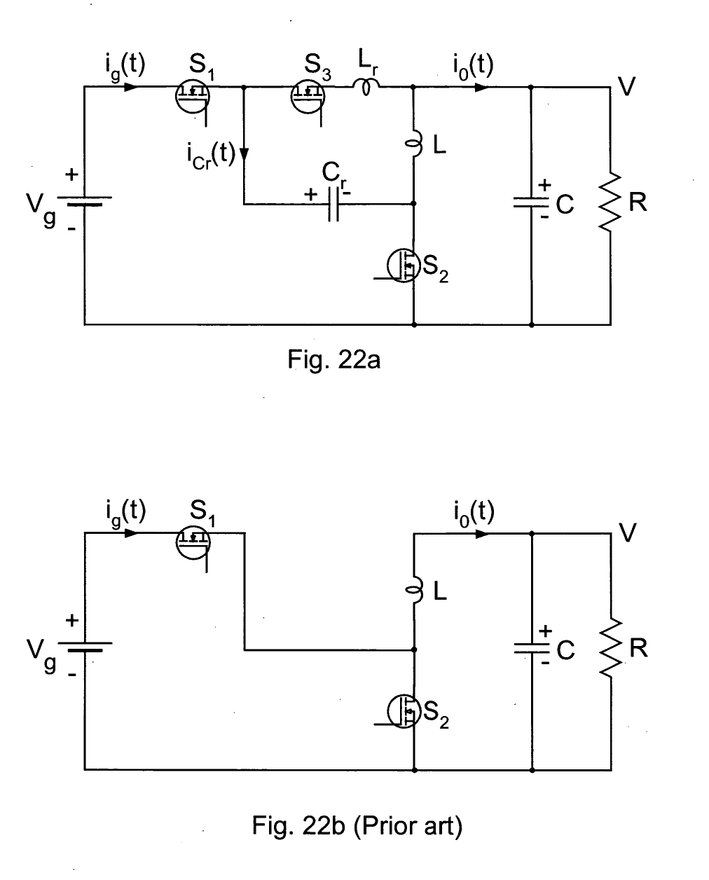

It is now appropriate to make further comparison of the three-switch step-down converter of the present invention as illustrated in FIG. 22a with the two-switch buck converter of FIG. 22b.

### Comparison of the Components Used

It is now interesting to observe the component differences between the buck converter and the present invention. The present invention (FIG. 22a) uses the components used in the buck converter (FIG. 22b). In addition, it appears to use an additional capacitor for resonant capacitor Cᵣ. However, in the buck converter the output capacitor C must be rather large to reduce the output ripple voltage to desired low value. Thus a small fraction such as 10% (as also corroborated by experimental design example in experimental Section) of the output capacitance C in the buck converter may be taken away from the output and inserted into present invention (FIG. 22a) to play the role of the resonant capacitance. In that position it actually has a dual role:
a) to transfer part of input power to output using capacitive energy transfer.
b) to reduce the ripple on the resonant capacitor to a fraction of its DC value and in doing so help to reduce the output ripple voltage by ratio of two capacitors.

The experimental results confirm that despite the use of same total capacitance, the present invention will result in output ripple voltage reduced by at least factor of two over comparable buck converter. The conclusion is that despite initial appearance, the present invention uses the same or less total capacitance then the two-switch buck converter.

The three-switch step-down converter has one additional magnetic component, the resonant inductor Lᵣ. As the detailed analysis and experimental data confirm, this inductor has 20 to 50 times smaller value than the PWM inductor L and thus is implemented as a one turn chip inductor typically in 90 nH inductance range. Ready made chip inductors such as TDK VLB7050HT-R09M are extremely small (7 mm×9 mm×4 mm) and yet they can handle in excess of 56 A current with 0.27 mΩ resistance. Thus its copper and core losses as well as size are in comparison to inductor L negligible. Its size is more than compensated by the significant increase of the size of inductor L needed for the buck converter.

The three-switch step-down converter has also one additional component, the third switch S₃. However, this switch conducts only a fraction of the load current. Its conduction losses are more than compensated with the increased conduction loses of the switch S₂ in the buck converter as the analysis in the next section reveals. Therefore, the present invention uses less total silicon area for its switches despite having the three switches as opposed to two switches of the comparable buck converter.

Finally, the general conclusion can be reached that the present invention uses less silicon, less magnetic material and less capacitive material than a comparable buck converter and yet results increased efficiency, reduced size and weight and reduced output voltage ripple over the full duty ratio D operating range.

### Comparison of Efficiencies

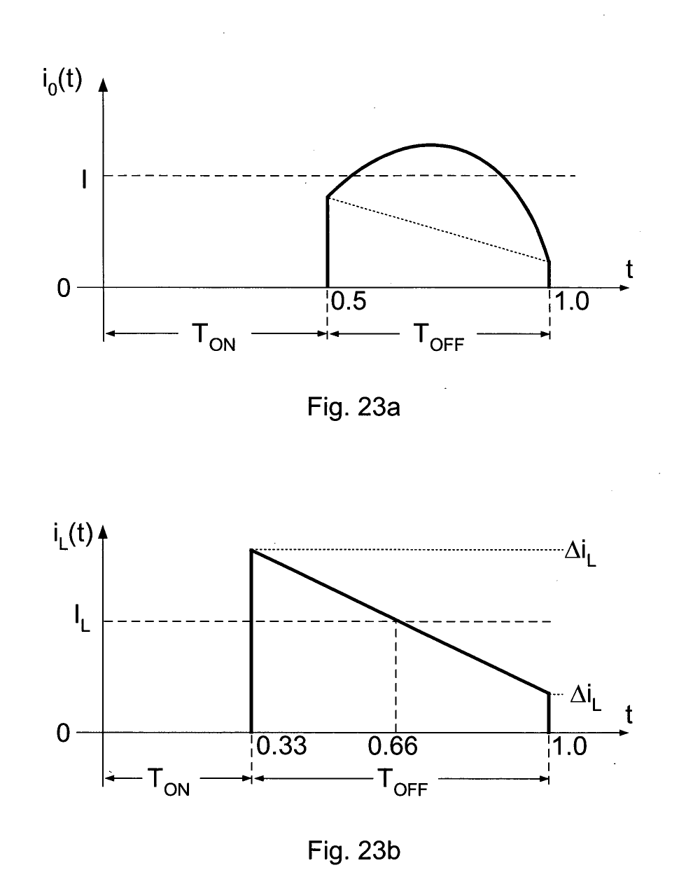

Due to the different DC conversion gains of the two as seen in FIG. 20a for the same overall step-down ratio of 3:1, the present invention operates at D=0.5 duty ratio and results in switch S₂ current waveform as shown in FIG. 23a. The buck converter, on the other hand must operate at a duty ratio of D=0.33 to result in the equivalent switch S₂ current as shown in FIG. 23b. Note that this results in significantly higher area and consequently higher conduction losses of the switch S₂ as utilized in the buck converter when compared its losses in the three-switch converter of the present invention. The switch S₃ is not present in the buck converter. However, the losses of this switch S₃ are in comparison much lower and more than amply compensated in reduced losses of switch S₂ in the present invention so that the total silicon used is actually considerably lower, while efficiency is higher at the same time.

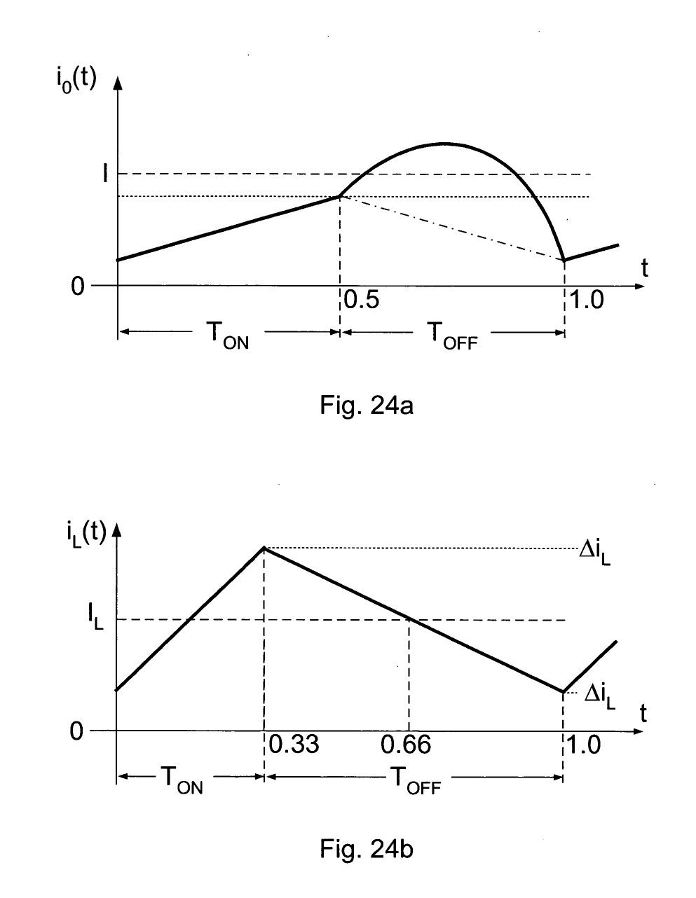

Note also that the inductor L in the buck converter must operate at higher DC current level (50% higher at D=0.5) than the inductor L in the present invention. Therefore, buck inductor must use appropriately larger air-gap which reduces its inductance and results in higher peak ripple and therefore higher turn-OFF current and losses of switch S₁ as illustrated by the comparison of the output current in present invention (FIG. 24a) and the output current in the buck converter (FIG. 24b). Note substantially larger peak turn-OFF currents in the buck converter, which together with larger blocking voltage, will result in substantially higher turn-OFF losses of switch S₁.

Note also the lower output ripple current of the present invention due to the current “bump” addition of the resonant inductor current contribution to the load current due to resonance during OFF-time interval. This is confirmed by actual experimental comparison in later section which results in factor of two reduction of output ripple voltage.

The theoretical prediction is that the present invention is more efficient and better performing than buck converter at any operating duty ratio D. The quantitative advantage is highlighted in the final Experimental Section in which both converters are built using effectively the same key components and their efficiency and losses compared at for the same conversion ratios. The conclusion reached is that three-switch converter provides reduction of losses of at least 50% over the full duty ratio operating range.

### Other Embodiments

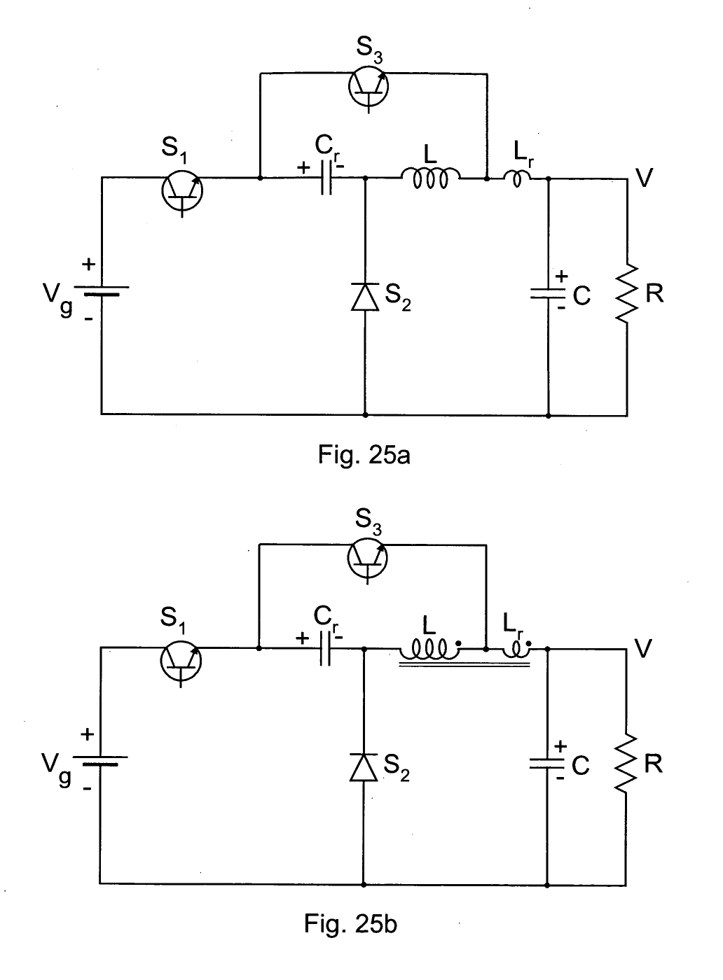

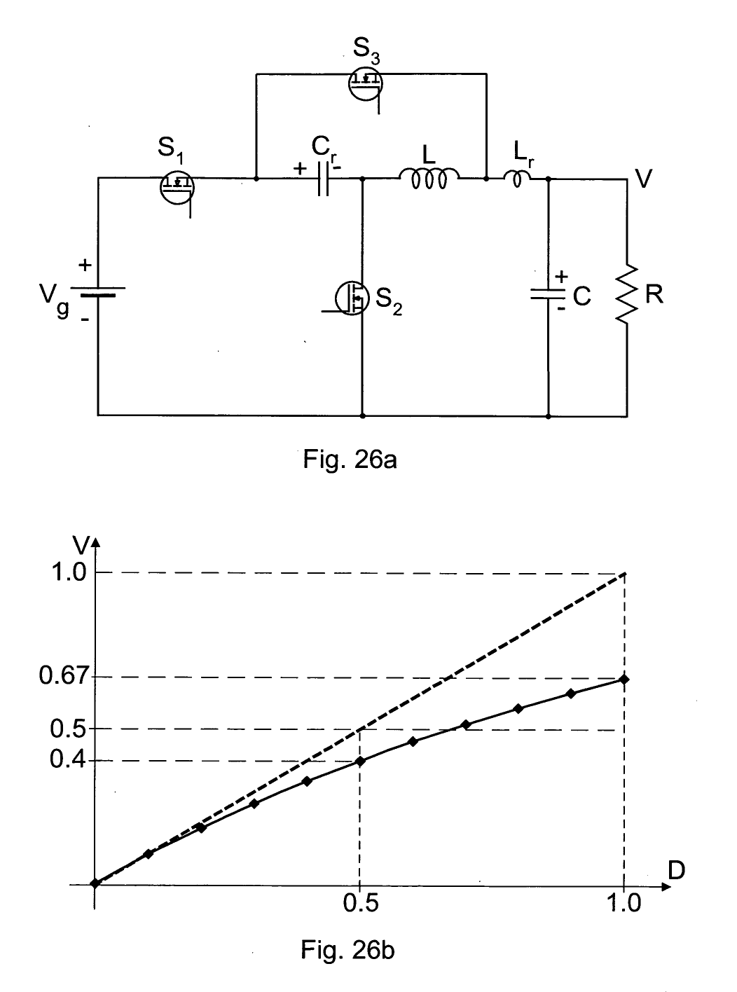

Several other embodiments of the present invention are obtained by placing the resonant inductor Lᵣ in different branches of the converter. For example, by placing the resonant inductor in the output branch, as shown in FIG. 25a another embodiment is obtained. This version has even a different DC conversion function, as is derived below for the case when Lᵣ=L. In addition under such condition, the two inductors form an effective 2:1 inductive voltage divider and could be coupled on a common core as illustrated in another embodiment on FIG. 25b. All transistor implementation is shown in FIG. 26a. For the special case when:

Lᵣ=L (41)

the DC voltage conversion ratio is obtained as:

V/V_{g}=D/(1+0.5D) (42)

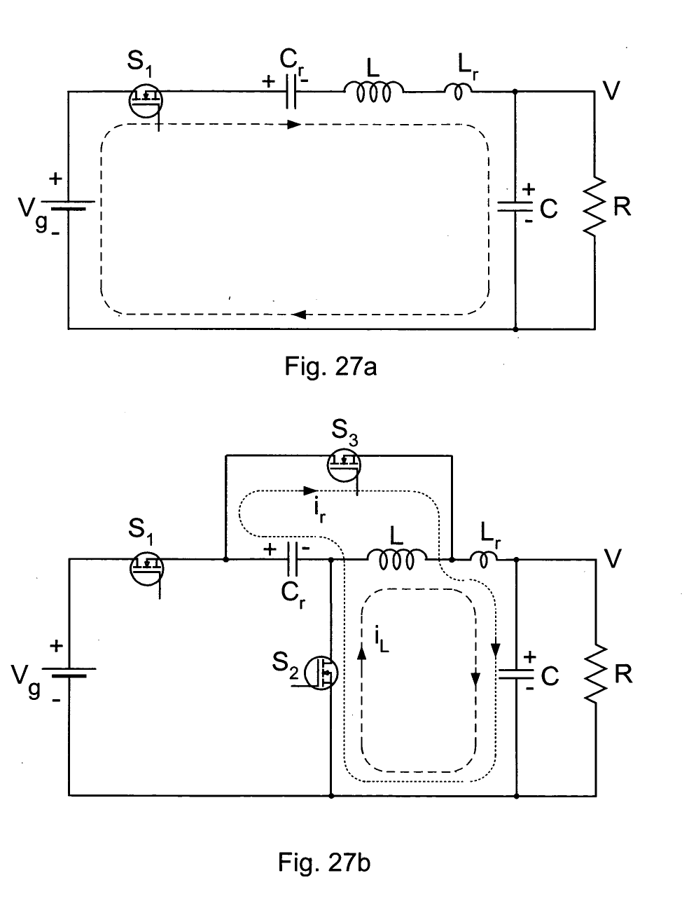

which is illustrated by solid line graph in FIG. 26b. Note that the DC conversion gain at D=0.5 is now 0.4 and not 0.33 as in the converter of FIG. 7a. Above equation is obtained by analyzing the equivalent circuit models in FIG. 27a and FIG. 27b, which yields:

Vᵣ=0.5V (43)

The same procedure as in previous analysis leads to DC conversion given by equation (42). It is also clear by choosing different values for Lᵣ other than (41) a number of different DC conversion gains could be obtained and plotted as a function of D.

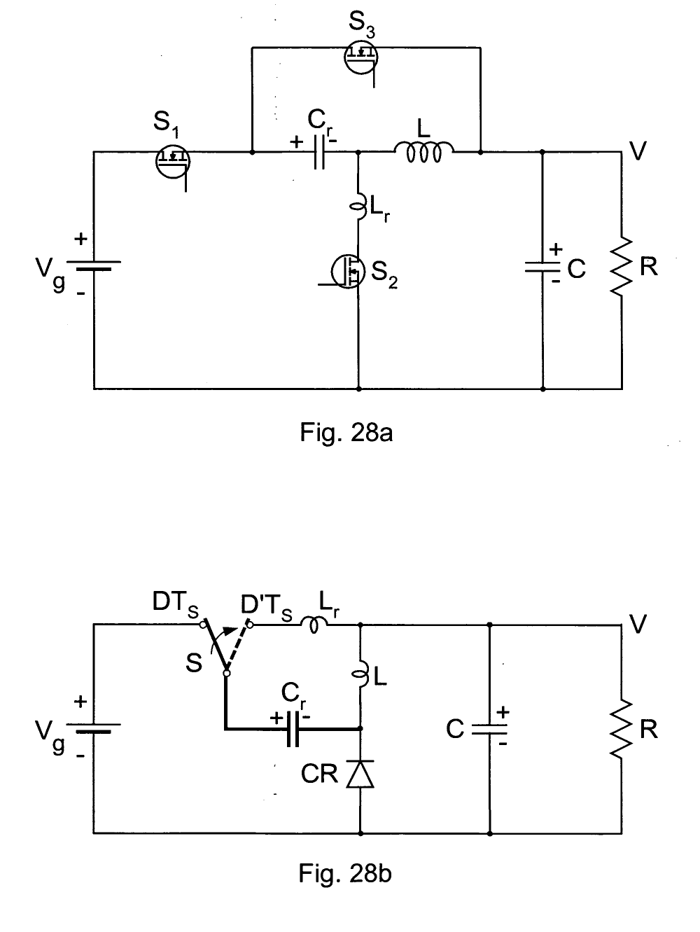

Yet another embodiment of the present invention is illustrated in FIG. 28a in which the resonant inductor Lᵣ is moved into the branch with S₂ switch and in series with it. Finally, the general converter topology could be represented by a single switch S with double pole and a diode switch as in FIG. 28b.

### Experimental Verification.

To verify the analytical equations derived and check the basic operation of the present invention an experimental prototype using three MOSFET switch configuration of FIG. 10b and of up to 60 W is built operating from 12V source into a full load of 4V, 15 A over the range of duty ratios from 0.5 to 0.33 and load currents from 5 A to 15 A. The following are the component values selected and the resonant frequency:

L=3.8 mH,Lᵣ=0.64 mH,Cᵣ=30 mF,C=960 mFfᵣ=36 kHz (44)

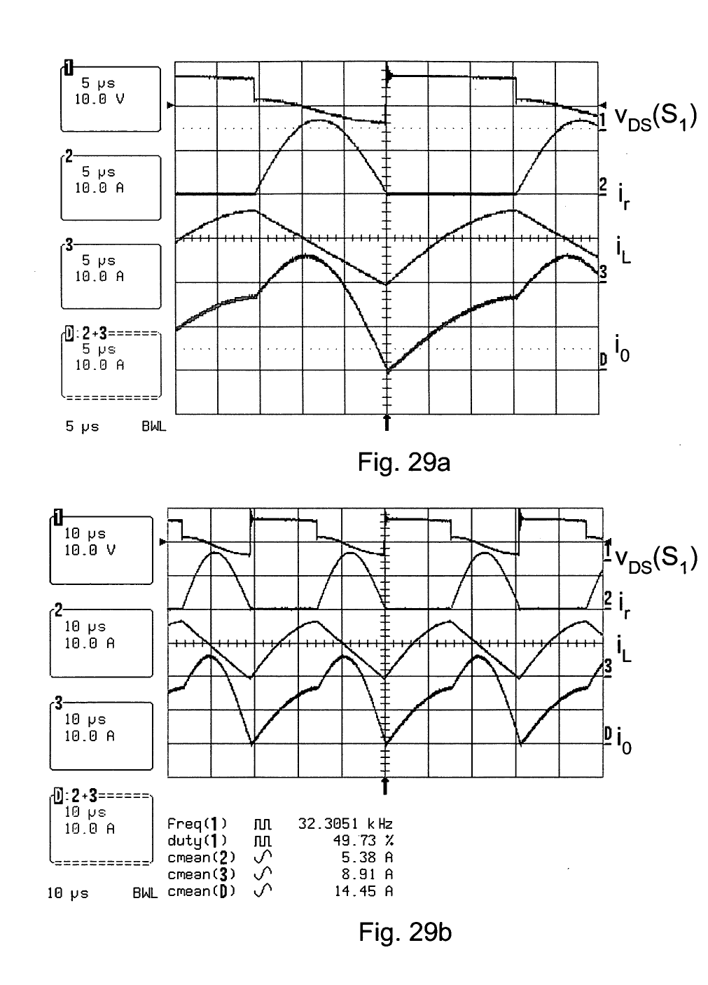

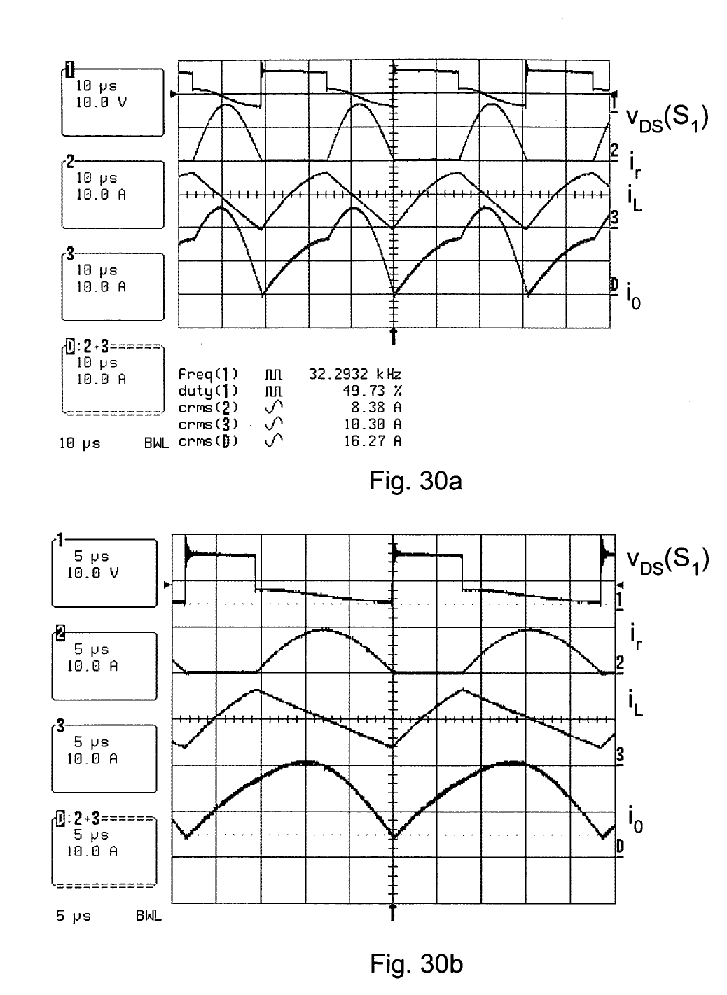

In this prototype there was no attempt to optimize performance for highest efficiency, but instead just to demonstrate characteristic waveforms. The experimental waveforms were recorded as traces on the oscilloscope are arranged so that the top trace shows the drain to source voltage of the controlling switch S₁, the second trace shows the resonant inductor current, the third trace shows the inductor L current and bottom trace shows the output current i₀ as the sum of the above two currents. FIG. 29a illustrates operation at D=0.5 and full load current of 15 A, which results in 4V output. The same waveforms are shown in FIG. 29b, but with the average (mean) value measured of the respective waveforms, so that the good correlation can be established with theoretical prediction. FIG. 30a then shows the rms current values of respective currents so that the conduction losses could be calculated and the relative loss contribution of various branches compared.

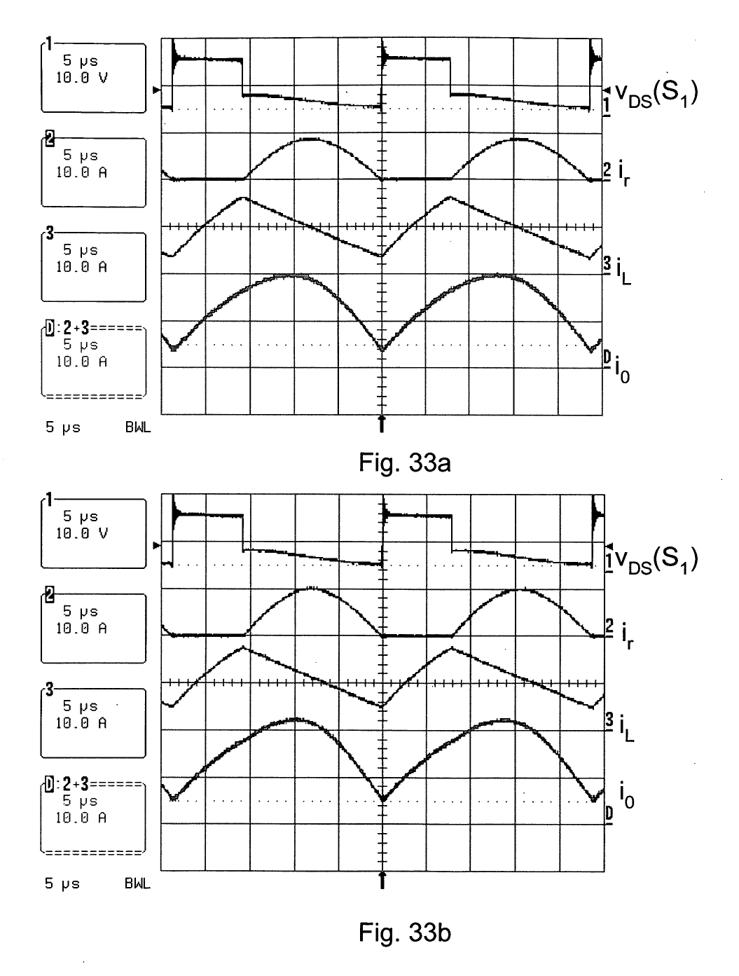

FIG. 30b shows the operation at D=0.33 and 15 A load, which results in 3V output voltage. Once again, FIG. 31a and FIG. 31b show the same waveforms, but with the included measurements of the mean and rms values of respective currents. FIG. 32a show the operation at D=0.33 and for 3 A load current. Note how the load current i₀ goes below zero current level for light load, while it is above zero level for load currents 8.5 A, 14 A and 18 A respectively shown in FIG. 32b, FIG. 33a, and FIG. 33b.

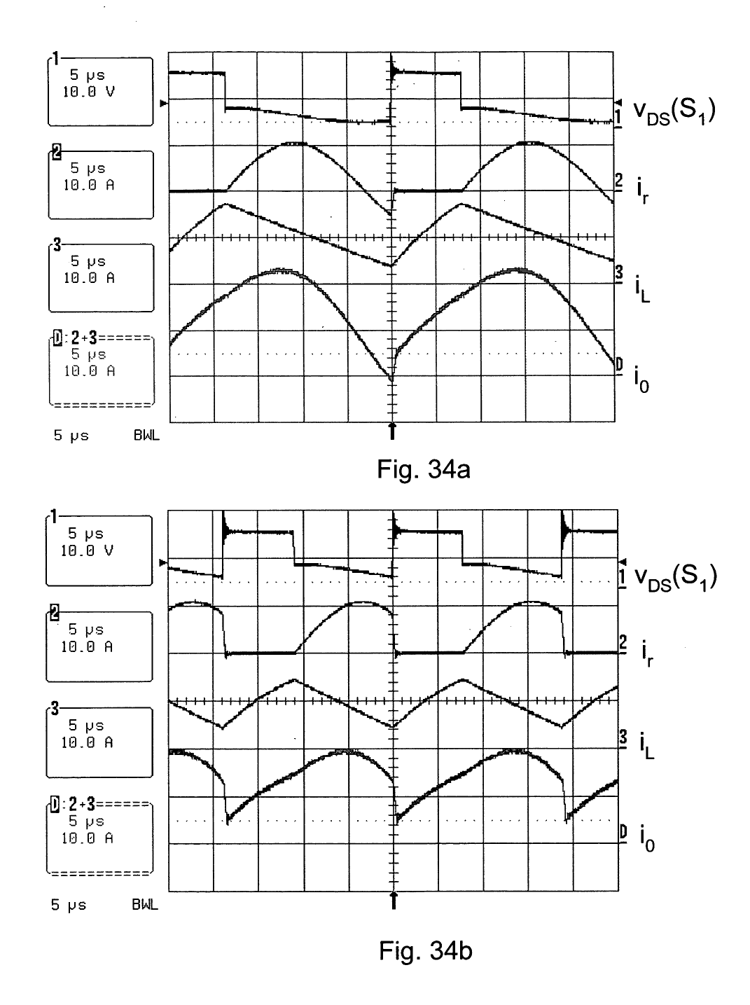

Shown in FIG. 34a is the condition when OFF-time period is longer than 50% of the resonant period Tᵣ thus allowing the instantaneous resonant current to go negative. Similarly, when the OFF-time is made shorter than 0.5Tᵣ the resonant current is cut-off before it reaches zero as seen in FIG. 34b.

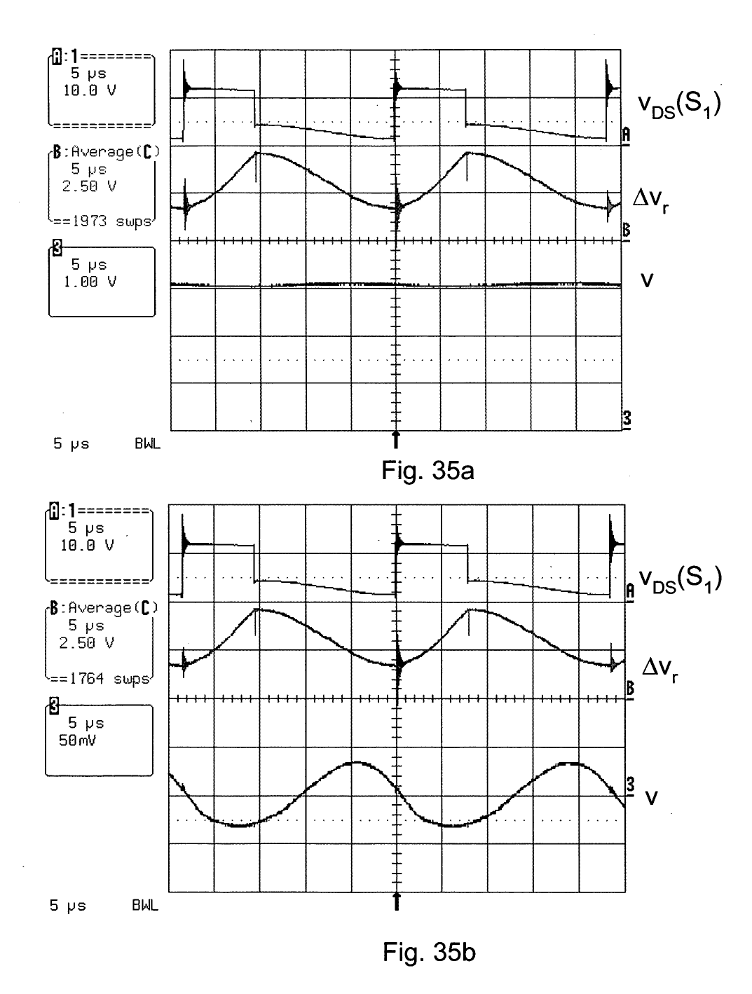

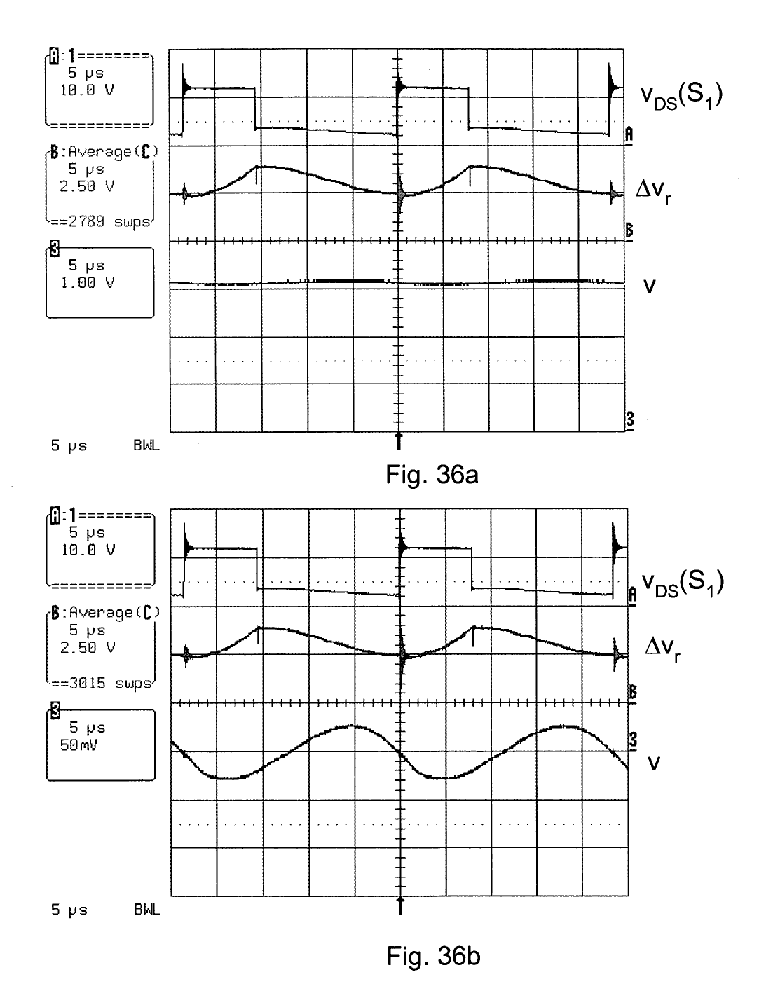

FIG. 35a shows for 15 A load current and 3V output, the capacitor voltage vᵣ with a superimposed AC ripple voltage on it as a second trace. The third trace shows the output DC voltage of 3V with superimposed AC ripple voltage on it. FIG. 35b shows the above voltage waveforms but with DC eliminated so that corresponding AC ripple voltages could be measured more accurately. FIG. 36a and FIG. 36b show the same waveforms for 50% load current of 7.5 A.

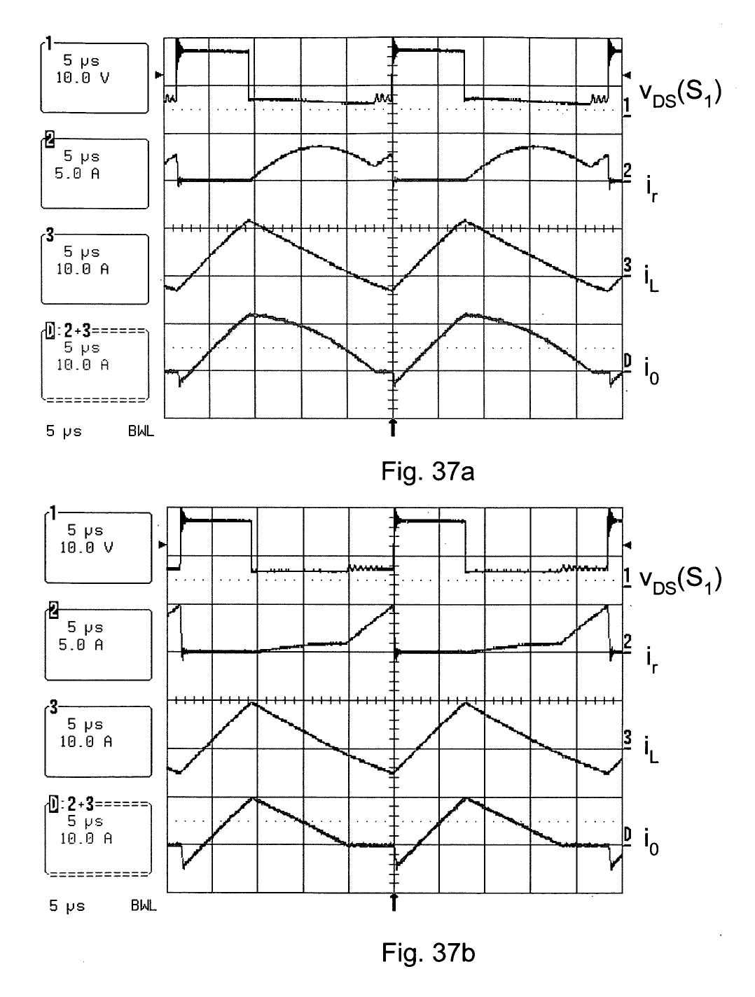

When the switch S₂ is implemented with a diode such as in FIG. 10a, the shape of some waveforms changes accordingly as shown in FIG. 37a and FIG. 37b, flattening output current at zero current level, when the diode stops conducting and corresponding waveform changes in the two inductors. It is apparent that the sum of the two instantaneous inductor currents is forced at certain point by diode implementation to be zero, so one current is positive and the other current is equally negative in a similar fashion as Discontinuous Inductor Current Mode in the Cuk converter.

### Experimental Verification of Efficiency

### Prototype of a 200 W, 48V to 12V Converter

To demonstrate ultra high efficiency of the three-switch DC-DC converter prototype is built based on the converter of FIG. 10b and with following specifications and component values:

Specifications: 200 W, 48V to 12V, 18 A converter.

### Components:

MOSFETS transistors:
S₁=IRFH5006; 60V; 4.1 mΩ

### S₂=2×IRFH5006

### S₃=IRFH5006,

Input capacitor: 20×10 μF
Output capacitor: 12×47 μF
Resonant capacitor: 10×2.2 μF
Resonant inductor: 200 nH (TDK chip inductor)
Inductor L: 8.2 μH (RM10 core size)
Resonant and switching frequency: 50 kHz

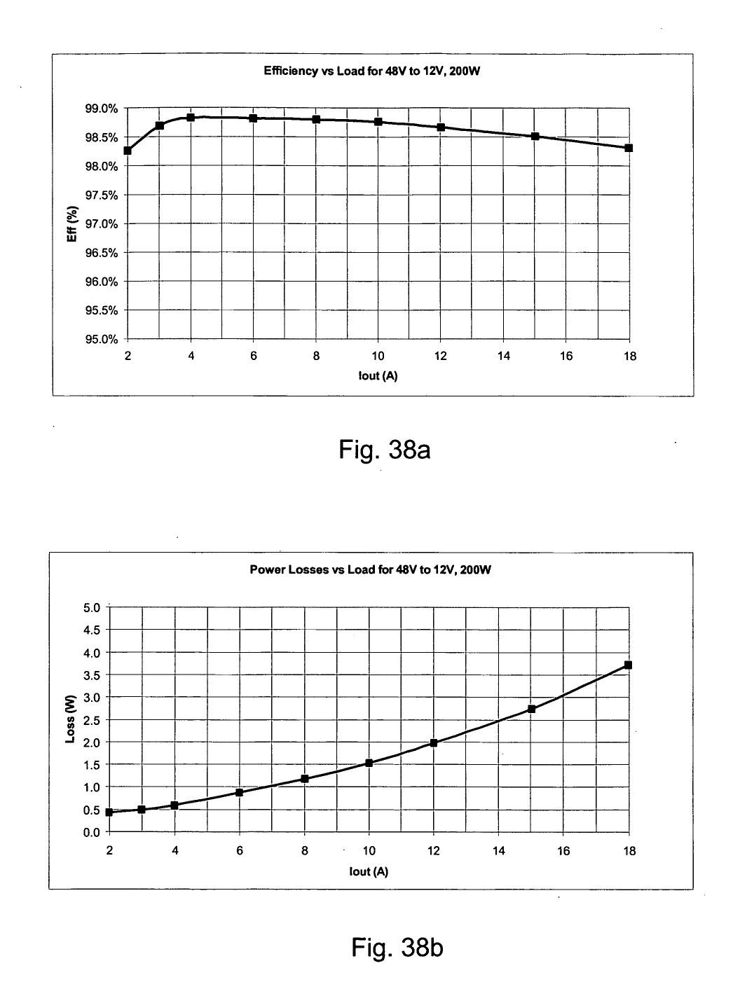

Graph of the efficiency and power loss as a function of the load current are shown in FIG. 38a and FIG. 38b respectively. Note that the efficiency over 98.5% is recorded over the wide load current range from 3 A to 15 A and power range from 36 W to 180 W. The maximum efficiency approaching 99% is recorded from 4 A to 8 A load currents. This confirms that the main losses remaining are of the conductive nature. Power loss curve also shows that the total dissipation is 1.5 W at the power level of 100 W and 2.75 W at power level of 180 W.

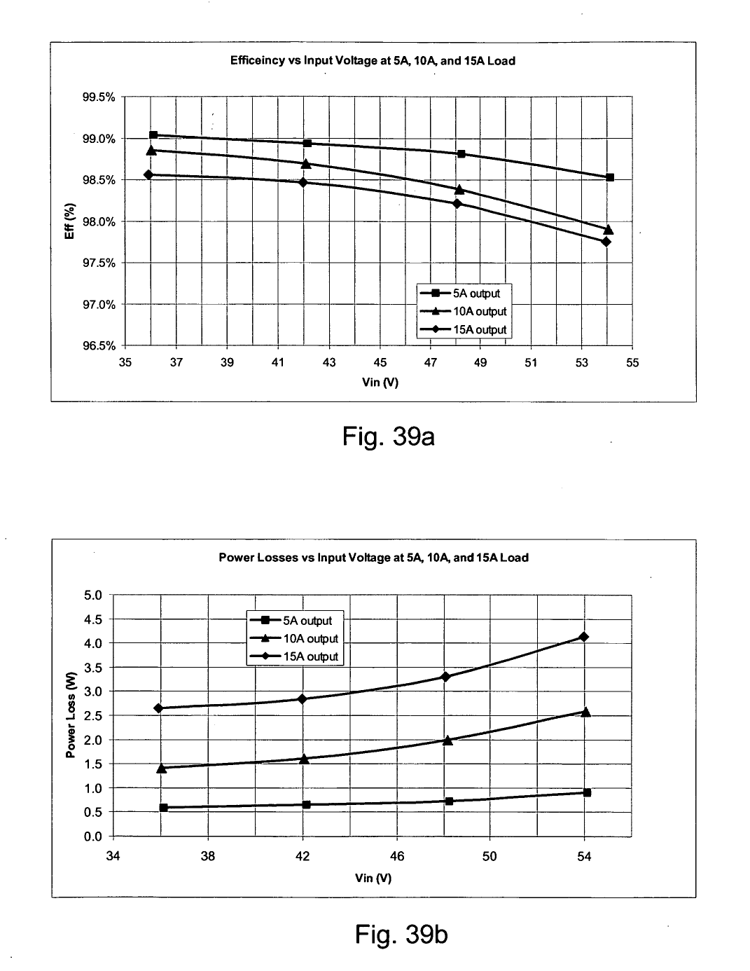

Another design is made on smaller RM8 core and was operated at 100 kHz switching frequency. For this design, the measurements of the efficiency over the input voltage regulation range from 36V to 54V are shown in FIG. 39a for three different values of the load current, 5 A, 10 A and 15 A. The corresponding loss data are shown in the graphs of FIG. 39b.

### Prototype of a 50 W, 12V to 1.5V Converter

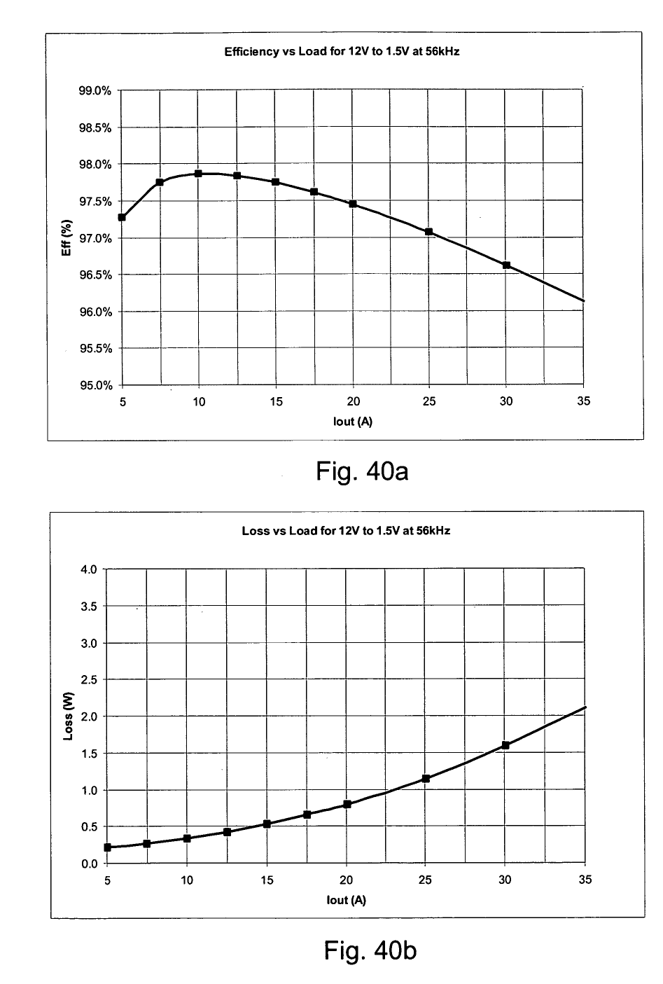

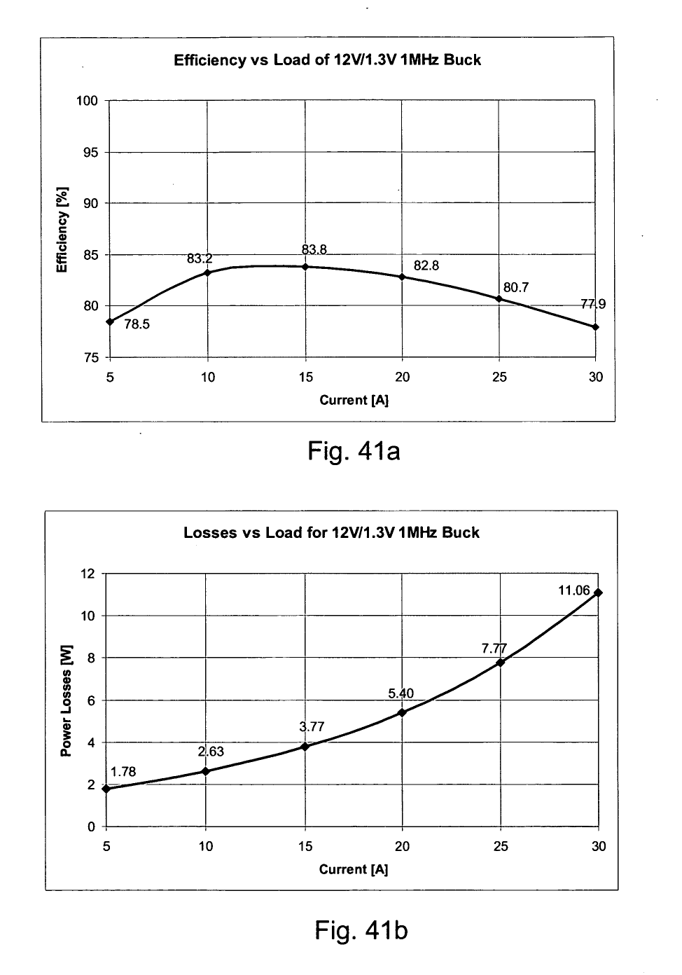

To verify ultra high efficiency of the converter for low output voltages, a three-switch converter of FIG. 10b was built operating at 56 kHz switching frequency and providing 1.5V at 30 A output from the 12V source. The efficiency is shown in FIG. 40a and losses in FIG. 40b The recently published experimental data (Ref. 5) obtained for a single buck converter module providing 1.3V @ 30 A from 12V input source are shown in FIG. 41a for efficiency and in FIG. 41b for losses. This comparison reveals much higher efficiency of the three-switch converter over the conventional two-switch buck converter.

### Hybrid Switching Method

The above detailed description of the three-switch step-down converter and its analysis discloses a new hybrid switching method, which is utilized in operation of this converter and number of its embodiments. A hybrid switching method comprises the two switching intervals, an ON-time interval and an OFF-time interval, two inductors, a PWM inductor and a resonant inductor and a resonant capacitor and three switches connected in such a way that the PWM inductor is flux balanced over an entire switching period, the resonant inductor is flux balanced only for a portion of the switching interval, during which it forms the resonant circuit with the resonant capacitor. The converter topology is such that the step-down conversion function is obtained through the duty ratio control of the main controlling switch. The other two switches are operating in an out of phase manner with the main controlling switch, so that when main controlling switch is ON, the other two switches are OFF to result in above mentioned two switching intervals.

Hybrid switching results in a small flux excitation applied to the resonant inductor and being completed during the OFF-time interval. The voltage excitation is a small co-sinusoidal AC ripple voltage superimposed on the DC voltage of the resonant capacitor. This results in its small size being an order of magnitudes smaller than the PWM inductor. It is important that this described hybrid switching method has only one resonance with resonant inductor Lᵣ that is completed during the part of the switching cycle. The other inductor L is subject to the larger square-wave excitation with positive Volt-second applied during ON-time interval and balancing negative Volt-seconds being applied during the OFF-time interval.

Despite hybrid switching, which involves a sinusoidal change of resonant current and resonant voltage during the resonant interval, the DC conversion gain and all other DC steady state quantities, such as DD current of inductor L, are independent of the resonant inductor and resonant capacitor, but are dependent on the duty ratio D only. This results in an easy and simple implementation of the feedback control and regulation following the same method as used for conventional converters.

The direct consequence of such duty ratio dependence is that hybrid switching can be implemented using the conventional feedback control methods as described next.

### Constant Switching Control

The control method introduced so far is constant OFF-time, variable ON-time control which ultimately means variable switching frequency. However, for the practical step-down conversion ratios, such as 4:1 and higher as used in experimental examples, the change of the ON-time period is relatively small from the nominal conversion ratio, so that even though a variable switching frequency is employed, he change of switching frequency is so small on the order of 20% from the nominal so that it may not be of any consequences in most practical applications. However, if so desired, a constant switching frequency and variable duty ratio could be employed at the minor sacrifice in efficiency.

### Phased-Shifted, Three-Switch, Step-Down Converters

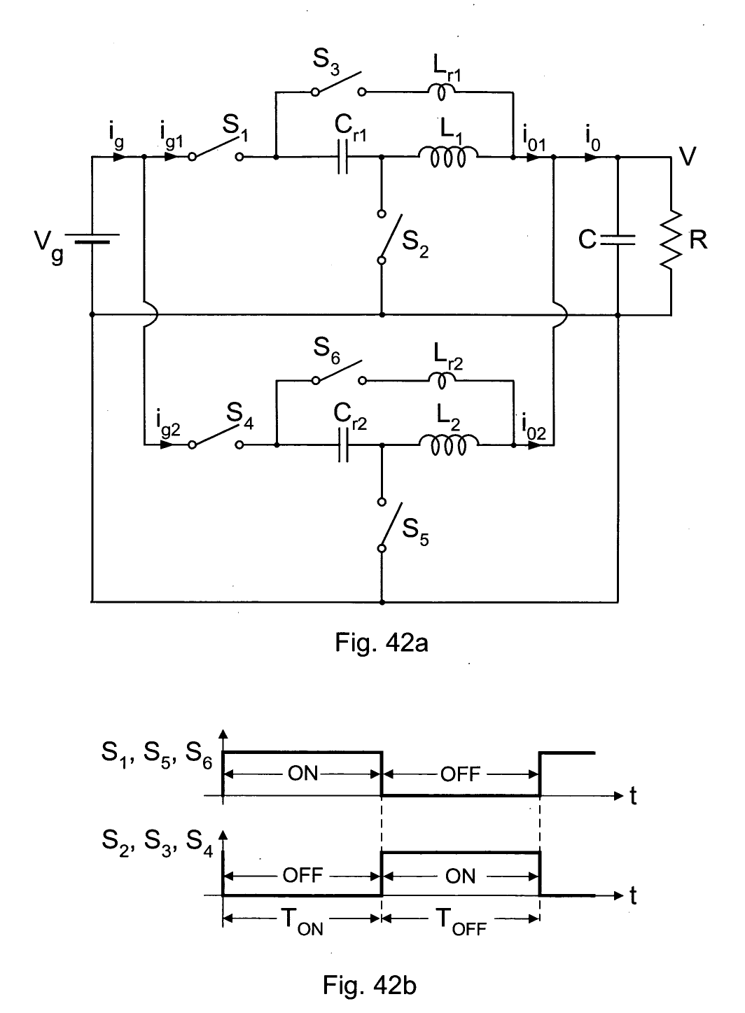

For voltages VRM applications requiring 1V output voltage and high 60 A load current, two three-switch, step-down converters can be connected in parallel to share the load equally at 30 A each, such as illustrated in FIG. 42a.

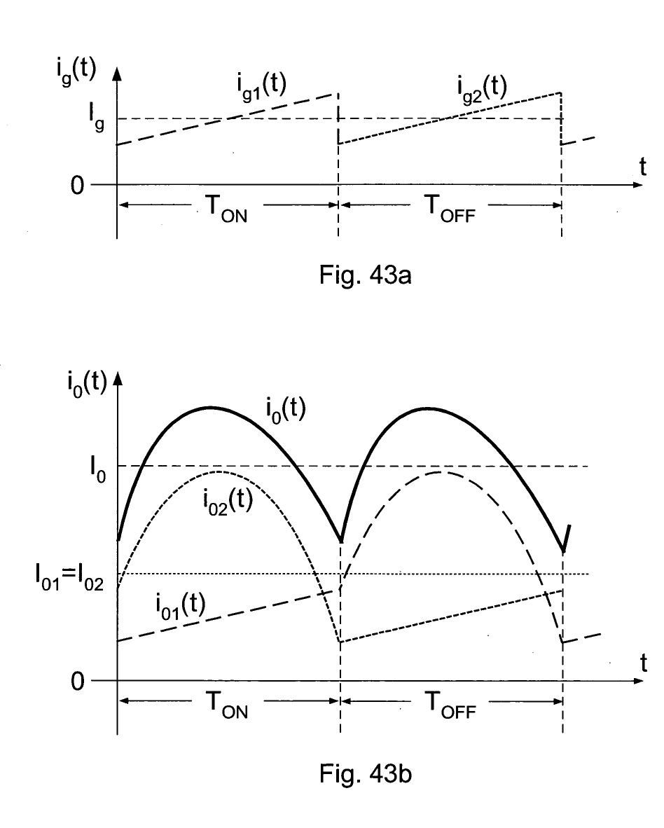

Additional advantages are realized when each converter is operated at nominal 50% duty ratio and their operation phase shifted, as illustrated by the switch state-diagram of FIG. 42b. Much reduced effective ripple current results in the input (FIG. 43a) and output (FIG. 43b).

### CONCLUSION

A three-switch step-down converter provides efficiency, size, cost and other performance advantages over the conventional two-switch buck converter and other conventional step-down converters over the entire duty ratio operating range.

Unlike buck converter which uses only inductive energy transfer, the present invention of three-switch step-down converter employs the capacitive energy transfer in addition to inductive energy transfer to result in much reduced losses and better utilization of the switches resulting in reduced cost of the silicon needed for given efficiency performance.

The present invention also introduces a new hybrid switching method, which implements for the first time the use of odd number of switches, such as three in this case, which is strictly excluded from use in conventional Square-wave, Resonant and Quasi-resonant switching converters, which require an even number of switches (2, 4, 6 etc.), operating as complementary pairs.

### REFERENCES

1. Slobodan Cuk, “Modelling, Analysis and Design of Switching Converters”, PhD thesis, November 1976, California Institute of Technology, Pasadena, Calif., USA.
2. Dragan Maksimovic, “Synthesis of PWM and Quasi-Resonant DC-to-DC Power Converters”, PhD thesis, Jan. 12, 1989, California Institute of Technology, Pasadena, California, USA;
3. Vatche Vorperian, “Resonant Converters”, PhD thesis, California Institute of technology, Pasdena, California;
4. Slobodan Cuk, R. D. Middlebrook, “Advances in Switched-Mode Power Conversion”, Vol. 1, II, and III, TESLAco 1981 and 1983.
5. Zhiiliang Zhang, Eric Mayer, Yan-Fei Liu and Paresh C. Sen “A 1 MHz, 12V ZVS Nonisolated Full-Bridge VRM With Gate Energy Recovery”, IEEE Transaction on Power Electronics, vol. 25, No. 3, March 2010.

What is claimed is:

1. A switching DC-to-DC converter for providing power from a DC voltage source connected between an input terminal and a common terminal to a DC load connected between an output terminal and said common terminal, said converter comprising:
a first switch with one end connected to said input terminal;
a second switch with one end connected to said common terminal;
a third switch with one end connected to another end of said first switch;
a resonant capacitor with one end connected to said another end of said first switch and another end of said capacitor connected to another end of said second switch;
a resonant inductor with one end connected to another end of said third switch and another end connected to said output terminal;
an inductor with one end connected to said another end of said second switch and another end connected to said output terminal;
switching means for keeping said first switch ON and said second switch and said third switch OFF during T_{ON} time interval, and keeping said first switch OFF and said second switch and said third switch ON during T_{OFF} time interval, where T_{ON} and T_{OFF} are complementary time intervals within one switch operating cycle T_{S};
wherein said resonant inductor and said resonant capacitor form a resonant circuit, and
wherein a DC-to-DC voltage step-down conversion ratio of said converter depends on said T_{ON} and T_{OFF} time intervals.

2. A converter as defined in claim 1,
wherein said first switch and said third switch are semiconductor bipolar transistors;
wherein said second switch is a semiconductor current rectifier (diode), having said one end being an anode and said another end being a cathode;
wherein said switching means include precise electronically controlling operation of said first switch relative to said third switch, whereby two transition intervals, a first transition interval and a second transition interval are created during which said first switch and said third switch are turned OFF, and
whereby said first and said second transition intervals are adjusted to minimize switching losses of said first switch and said second switch.

3. A converter as defined in claim 2,
wherein said first switch and said third switch are semiconductor MOSFET transistors, and
whereby said first switch and said third switch have substantially reduced conduction losses.

4. A converter as defined in claim 3,
wherein said second switch is a semiconductor MOSFET transistor,
wherein said switching means keep said second switch ON during said T_{OFF} time interval and OFF during said T_{ON} time interval, and
whereby said second switch has substantially reduced conduction losses.

5. A converter as defined in claim 1,
wherein an additional converter, same as said converter in claim 1, is connected in parallel to said converter in claim 1;
wherein both said converters operate at equal duty ratios of D=0.5;
wherein said additional converter operates out of phase with said converter of claim 1 so that when said first switch is turned ON, a first switch of said additional converter is turned OFF, and
whereby voltage at said DC load has substantially reduced ripple voltage.

6. A converter as defined in claim 1,
wherein said another end of said third switch is disconnected from said one end of said resonant inductor and connected to said output terminal,
wherein said another end of said second switch is disconnected from said another end of said resonant capacitor and connected to said one end of said resonant inductor, and
wherein said another end of said resonant inductor is disconnected from said output terminal and connected to said another end of said resonant capacitor.

7. A converter as defined in claim 6,
wherein said first switch and said third switch are semiconductor bipolar transistors;
wherein said second switch is a semiconductor current rectifier, having said one end being an anode and said another end being a cathode;
wherein said switching means include precise electronically controlling operation of said first switch relative to said third switch, whereby two transition intervals, a first transition interval and a second transition interval are created during which said first switch and said third are turned OFF and
whereby said first and said second transition intervals are adjusted to minimize switching losses of said first switch and said second switch.

8. A converter as defined in claim 7,
wherein said first switch and said third switch are semiconductor MOSFET transistors, and
whereby said first switch and said third switch have substantially reduced conduction losses.

9. A converter as defined in claim 8,
wherein said second switch is a semiconductor MOSFET transistor,
wherein said switching means keep said second switch ON during said T_{OFF} time interval and OFF during said T_{ON} time interval, and
whereby said second switch has substantially reduced conduction losses.

10. A converter as defined in claim 6,
wherein an additional converter, same as said converter in claim 6, is connected in parallel to said converter in claim 6;
wherein both said converters operate at equal duty ratios of D=0.5;
wherein said additional converter operates out of phase with said converter of claim 6 so that when said first switch is turned ON, a first switch of said additional converter is turned OFF, and
whereby voltage at said DC load has substantially reduced ripple voltage.

11. A switching DC-to-DC converter for providing power from a DC voltage source connected between an input terminal and a common terminal to a DC load connected between an output terminal and said common terminal, said converter comprising:
a first switch with one end connected to said input terminal;
a second switch with one end connected to said common terminal;
a third switch with one end connected to another end of said first switch;
a resonant capacitor with one end connected to said another end of said first switch and another end of said capacitor connected to another end of said second switch;
a resonant inductor with one end connected to another end of said third switch and another end connected to said output terminal;
an inductor with one end connected to said another end of said second switch and another end connected to said one end of said resonant inductor;
switching means for keeping said first switch ON and said second switch and said third switch OFF during T_{ON} time interval, and keeping said first switch OFF and said second switch and said third switch ON during T_{OFF} time interval, where T_{ON} and T_{OFF} are complementary time intervals within one switch operating cycle T_{S};
wherein said resonant inductor and said resonant capacitor form a resonant circuit, and
wherein a DC-to-DC voltage step-down conversion ratio of said converter depends on said T_{ON} and T_{OFF} time intervals.

12. A converter as defined in claim 11,
wherein said first switch and said third switch are semiconductor bipolar transistors;
wherein said second switch is a semiconductor current rectifier (diode), having said one end being an anode and said another end being a cathode;
wherein said switching means include precise electronically controlling operation of said first switch relative to said third switch, whereby two transition intervals, a first transition interval and a second transition interval are created during which said first switch and said third are turned OFF, and
whereby said first and said second transition intervals are adjusted to minimize switching losses of said first switch and said second switch.

13. A converter as defined in claim 12,
wherein said first switch and said third switch are semiconductor MOSFET transistors, and
whereby said first switch and said third switch have substantially reduced conduction losses.

14. A converter as defined in claim 13,
wherein said second switch is a semiconductor MOSFET transistor,
wherein said switching means keep said second switch ON during said T_{OFF} time interval and OFF during said T_{ON} time interval, and
whereby said second switch has substantially reduced conduction losses.

15. A converter as defined in claim 11,
wherein an additional converter, same as said converter in claim 11, is connected in parallel to said converter in claim 11;
wherein both said converters operate at equal duty ratios of D=0.5;
wherein said additional converter operates out of phase with said converter of claim 11 so that when said first switch is turned ON, a first switch of said additional converter is turned OFF, and
whereby voltage at said DC load has substantially reduced ripple voltage.

16. A method for hybrid switched-mode DC-to-DC step-down power conversion comprising:
providing two controllable three-terminal switches and one two-terminal switch, all having an ON-time interval DT_{S} and an OFF-time interval (1−D)T_{S} within a switching time period T_{S} where D is a duty ratio of the switches;
providing an PWM inductor operating and being flux-balanced over the entire said switching time period T_{S};
providing a resonant inductor operating and being flux-balanced during a part of said switching time interval T_{S};
providing a resonant capacitor being charged from a DC source during said ON-time interval and being discharged in a resonant fashion through said resonant inductor into a DC load;
controlling said ON-time and said OFF-time intervals by said two controllable three-terminal switches regulating a voltage on said DC load;
providing PWM voltage and current waveforms on said PWM inductor during entire said switching time interval T_{S};
providing resonant voltage and current waveforms on said resonant inductor during said OFF-time interval;
initiating a PWM operation mode by turning one of said two controllable three-terminal switches ON while another controllable three-terminal switch is OFF;
initiating a resonant operation mode by turning said one controllable three-terminal switch OFF and turning said another controllable three-terminal switch ON;
providing a resonant circuit comprising said resonant capacitor and said resonant inductor by keeping said another controllable three-terminal switch ON and having said two-terminal switch ON during said OFF-time interval;
providing said resonant inductor and said resonant capacitor form a resonant circuit during said OFF-time interval and define a constant resonant frequency and corresponding constant resonant period;
controlling said OFF-time interval to be equal to one half of said constant resonant period.

17. A method for hybrid switched-mode DC-to-DC step-down power conversion as defined in claim 16 wherein said two controllable three-terminal switches are bipolar transistors and said two-terminal switch is a diode.

18. A method for hybrid switched-mode DC-to-DC step-down power conversion as defined in claim 17 wherein said two controllable three-terminal switches are MOSFET transistors.

19. A method for hybrid switched-mode DC-to-DC step-down power conversion as defined in claim 18 wherein said diode switch is replaced with a MOSFET transistor being turned ON and OFF as a synchronous rectifier to reduce conduction losses.

20. A method for hybrid switched-mode DC-to-DC step-down power conversion as defined in claim 16 wherein two equal converters operate in parallel and out of phase at the same duty ratio D=0.5 providing substantially reduced voltage ripple at output DC load.
